(19) United States
(12) Patent Application Publication
(10) Pub. No.: US 2008/0203346 A1
(43) Pub. Date: Aug. 28, 2008

(54) Fluid control system

(76) Inventor: Jianchao Shu, Winston, GA (US)

Correspondence Address: JIANCHAO SHU, 3719 FALLS TRAIL, WINSTON, GA, 30187, US

(21) Appl. No.: 11/894,210

(22) Filed: Aug. 20, 2007

Related U.S. Application Data
(62) Division of application No. 11/023,330, filed on Dec. 27, 2004, now abandoned.
(60) Provisional application No. 60/533,337, filed on Dec. 29, 2003.

(51) Int. Cl. F16K 31/44

(52) U.S. Cl. 251/214

(57) ABSTRACT

This invention provides a fluid control system for regulating flow fluid under extreme conditions and includes a reciprocal a reciprocal 1 control module and rotary control module. This system provides energy transmission devices to regulate a flow fluid rate and flow fluid pressure in different manners with minimum pressure loss consequences. This system also has a dynamic stem seal assembly which comprises an inclusive stem packing, bore packing, and secondary seal for compensating any offset and is provided with a leakage between 10-500 ppm and a controllable loading device and a dynamic seat seal assembly which comprises a body seal and valve member seal for compensating any offset and is provided with zero leakage and novel mapped solutions with a metal-to-metal seal ultimate goal-pointed seal ring. This system provides a number of novel mechanical joint devices.

### CROSS REFERENCE TO RELATED APPLICATION

Provisional Patent Application Ser. No. 60/533,337 filed 20003 December 29 This is a division of Ser. No. 11/023,330 filed Dec. 27, 2004

### FEDERALLY SPONSORED RESEARCH

Not Applicable

### SEQUENCE LISTING OR PROGRAM

Not Applicable

### BACKGROUND

1. Field of Invention

This invention relates to novel fluid control mechanisms, seal technologies and mechanical assembly structures, more particularly, to a fluid control system with those novel features used for regulating flow fluid under extreme conditions; such as extreme temperature, pressure and velocity and viscosity.

2. Description of Prior Art

Conventional fluid control systems or valves are generally employed for regulating a flow fluid pressure or a flow fluid rate. The conventional fluid control systems are used for regulating the pressure, sometime those valves causes high fluid pressure drop or energy loss, as a result the high fluid pressure drop contributes to noise, vibration, erosion and cavitations as well as damages on the fluid control systems. The conventional fluid control systems or valves are also used for regulating the fluid flow rate, but those valves have lower performances with undesirable pressure drops and are expensive to produce, moreover those valves have a high tendency of leakage under extreme conditions. The leakage in the valves causes low operation efficiency and various forms of environment pollution, so extra shut-off valves are required along with the control valves for some critical services, such an arrangement not only increase cost, but also add more parameters for the control loop. Therefore more and more strict regulations for environment protection are imposed on the fluid related industries, meanwhile the fluid related industries such as refineries, chemical plants, power plants and engine makers are forced to compete with their rivals by reducing operation cost and developing new products or services and demand the fluid control systems which are safe, reliable and versatile with lower fugitive emissions, less energy consumption at lower cost. As a result the control valve industries are not only faced with those new challenges but still have old unsolved problems; high stem leakage, seat leakage, vibration, noise, inefficient fluid control mechanism, unsafe and unreliable mechanical assembly structures, high cost and short life of their products.

In order to overcome the disadvantages of the conventional control valves and meet new challenges, many efforts have been made in the prior arts and classified into four aspects (1) flow fluid control mechanism (2) stem seal (3) seat seal (4) mechanical assembly structures, but those efforts are made separately from each other within a limited scope, the results are not satisfying at the current level.

In aspect of the fluid control mechanisms, many efforts in prior arts were made for fluid pressure reduction, but the results are undesirable in terms of performances and costs. The significant efforts were made by Robert E. Self in U.S. Pat. No. 3,514,074 (1970) for fluid pressure reduction, the new approach in U.S. Pat. No. 3,514,074 is to dissipate fluid energy gradually and to avoid high velocity fluid by reducing and expanding cross sections of multiple flow paths as well as changing the direction of the flow paths on multiple stacked disks. This approach eases consequences of high velocity; noise, vibration and cavitations, but it requires a very expensive process to produce the complicated flow paths and high maintenance cost for replacing the damaged disks caused by local impact fatigue—repetitive flow fluid impact forces against solid material surfaces, which are not even recognized, moreover there is no efforts to reduce pressure loss in those applications for regulating flow fluid rates where the pressure loss is undesirable. Although many new patents have been issued in the field since then, the approaches in the prior arts are all very similar to U.S. Pat. No. 3,514,074, furthermore most of fluid energy loss in the prior arts is accomplished through energy exchange among flow fluid itself, only a small portion of the energy exchange takes place between flow fluid and solid parts in conventional control devices as heat, mechanical forms of energy. And most of the pressure loss as a form of potential energy is changed to kinetic energy by a series of stages, so the improvement is that the damage by the loss energy happens on a number of parts instead of damage on few parts, those parts like the valve trim, sleeve, cages and plugs are made out of rigid, hard metals with very complicated shapes of flow paths and must be manufactured by expensive equipments such as laser cutters or precision process, but those parts still suffer constant damages due to local impact fatigue, resonance of vibration and cavitations by high velocity flow fluid.

The developments of fluid control valves have reached the bottleneck. The conventional fluid control theory based on Bernoulli's formula and derivative formulas or equations adopted by the industrial associations has dominated the fluid control system and valve developments for centuries, but there are some limitations of the conventional fluid control theory which prevents the fluid control valve manufacturers from further improvements; (1) the theory is not applicable for the transient state of fluids (2) the assumption of continuation of fluids causes significant errors in calculation of fluids characteristics at a phase change between liquid and gas and at vena contracta (3) the definition of pressure of fluids is lacking a description at a molecular level (4) the theory fail to state that it takes time for energy exchange between the potential energy represented by pressure and kinetic energy represented by velocity.

In aspect of the stem seal, the efforts to improve the stem seal are to add more stem seal packing sets, more seal force with more storing energy to both rotary and reciprocal stems. Live load packing devices are one of those efforts shown in U.S. Pat. No. 5,230,498 to Charles W. Wood (1993), U.S. Pat. No. 5,503,406 to Leonard T. Armstrong (1996) and U.S. Pat. No. 5,860,633 to Ryan E. Murphy et al (1999). Those packing devices are not only expensive, inefficient and unsuitable for temperatures over 460 F., but also require more operation power to actuate the stems and wear out the packing and stems prematurely. A recent survey shows that 50% of the control valve failures are contributed by excessive stem packing forces.

U.S. Pat. No. 4,886,241 to James R. Davis et al (1989) and U.S. Pat. No. 4,394,023 to Alberto L. Hinojosa (1983) disclose stem seals with graphite packing for high temperature applications, but the stem packing seals require more torques and the leakage can not be quantified. U.S. Pat. No. 6,202,668 to Robert E. Maki (2001) and U.S. Pat. No. 4,082,105 to Hebert Allen (1978) show fire-resistant stem seals. The fire-resistant stem seals are provided with a first PTFE seal and a secondary metal seal, in case of fire or temperature elevation, the secondary metal seal will replace the first PTFE seal, but in reality such a stem seal proves to be unreliable and has high leakage.

Finally U.S. Pat. No. 6,250,604 to Raoul W. Robert (2001) shows other efforts to weld additional harder materials to a reciprocal stem in order to prolong the stem life and improve a seal, but this stem requires expensive processes of welding, grounding and polishing, the boundaries between a welded material and a base material are more vulnerable to be corroded than one material stem, moreover under high temperature the differential thermal conductivity and expansion between the welded material and the base material can cause stem leakage and accelerate the corrosion process.

In short, those prior arts in the stem seal field have common disadvantages:

(1) A static stem seal is misused for dynamic seal applications. The stem seals in the prior arts are based on a static, ideal geometric fit between a stem and a packing or rings, but in the reality when the stems are rotated or sliding, an axis of the stem and that of packing or ring are never aligned up or concentric, so each thickness of every location of a gap between the stem and the packing is uneven and variable, the locations and magnitude of the largest thickness are changing as the stem is moving, an inside diameters of the packing which is attached to a bore or packing support are enlarged by the moving stem and continuously cause stem leak, so the efforts were made to increase and keep high axial forces on the packing to fill in the gap based on the largest thickness, as a result, the gap at the smallest thickness has excessive seal force and high friction, so more power is required to operate the stem and wear out the stem and the packing prematurely.
(2) Inefficiency of packing loading. According to the Hook Law, only about 30% of axial force in most materials is converted to radial displacements of the packing which helps fill in the gap between the stem and the packing. With consideration of frictions, lower density or material creeps under high temperature, the efficiency of the conversion even becomes worse about 10-20%, so the conventional axial loading packing devices are inefficient and expensive to produce and have more undesirable forces.
(3) High-energy consumption. The conventional methods to improve stem seal are to increase the number of packing sets, seal force or to add harder materials to the stem. Such methods in fact are to increase energy consumption between the stem and the packing when stem is moving, as a result the more energy consumed, the more parts damaged. At a nano-structure, the stem and the packing can be modeled as a pair of a cylindrical bar and a bore with a plurality of bosses which are considered as cantilever beans under forces, the bosses in the stem are engaged with the bosses in the packing, when the stem is moving, the energy is transferred from an external source to the stem and the packing through bending each other, some of them are broken down as wearing out, a portion of the external energy is transferred to the broken parts, some of them are not broken, a portion of the external energy is stored in the stem and the packing, as a result total bending forces on the bosses generate the friction and wearing as a whole, the broken bosses on the stem and the packing are caused by the boss bending or fatigues, so a material with a finer surface, less or smaller boss or more flexible property has a lower coefficient of friction and less energy consumption, moreover the flexible material bosses can store more energy and reduce the wearing and friction.
(4) Non-inclusive, unsafe stem packing design. Most conventional stem packing seals are non-inclusive and difficult to control in case of mass leak of fluid or fire and have no overload protection for the packing loading, without the overload protection the excessive load force can shut down the valve operation. Some of the stem packing seals have sealant injection port, but in some cases like a fire, remote area control operation, the sealant injection is either not an option or unworkable.

In aspect of the seat seal, many efforts were made, especially in metal to metal seat seal in high temperature, cryogenic environments or for highly abrasive or erosive fluid applications. The significant efforts were made by Karl Adam as shown in U.S. Pat. No. 3,442,488 (1969), a butterfly valve with a triple offset arrangement for reducing rubbing between a seat and a seal ring or disc and increasing the life of the seat seal, but the seat seal itself was not improved and has a solid surface vs. a solid surface seal, such a seal causes high operation torque and requires expensive precision machining and assembly. U.S. Pat. No. 4,667,929 to Franco Narduzzi (1986) discloses a similar offset arrangement on a ball valve, a seat seal is provided with a solid surface on a body against a solid surface on a ball, a seal ring on the ball is made out of a composite metal material with heat resistant and deformable natures, in the reality such an ideal material is difficult to make, moreover a secure means was not clearly disclosed, the secure means is the other key factor for a good metal seal under high temperature, without a good seat secure means, a stable metal seat seal is impossible. U.S. Pat. No. 3,905,577 to Anatole N. Karpenko (1975) discloses a replaceable laminated seat against solid surface of disc, this seat would be a good choice for a metal to metal seat seal, but the bolts and rivets used as a secure means completely constrain the seat thermal expansion under high temperature, as the temperature increases, the seat will deform and loosen a seal.

U.S. Pat. No. 4,037,819 to Peter G. Kindersley (1977) shows other metal to metal seat seal which has a solid surface vane against a flexible seal ring, such a seat seal has a lower operation torque, but the flexible ring has an unmatched seal surface against the vane and two floating ends, this seat seal is unstable under high pressure or high cycle condition and is vulnerable to any point damage on the seal ring. U.S. Pat. No. 5,377,954 to Siegbert Adam et al (1995) discloses a metal seat seal which has a solid surface vane against a flexible seal ring assembly, the flexible seal ring assembly has multiple rings with one support end and an unmatched seal surface against the vane, such a seat seal is stronger and more stable than seat seal in U.S. Pat. No. 4,037,819, but the seat seal still is unstable under high pressure or high cycle condition and also creates a new problem which is fluid seeping between the rings, although a wedge welded by a laser welder is provided as a remedy, such a weld process brings out another problem which is deformation of seal ring after welding, such deformation can generate more leakage on external surfaces of the ring, above all, the seat seal is unstable and vulnerable to fluid contamination and any point damage on the seal.

U.S. Pat. No. 5,871,203 to Jerry Gassaway (1999) shows a widely used, laminated seat ring as a replaceable seat ring, but the replaceable seat ring without a secure means has a disadvantage in high temperature or high cycle environments, the different thermal expansion between a body and the seal ring can cause leakage through the seat ring. On the reciprocal control valve like the gate valve, control valve, engine valve, needle valve, fuel metering valve, solid metal to solid metal seat seal is still dominated, such a seal not only has less sealability, but also is expensive to produce and repair with hard material layer. U.S. Pat. No. 6,536,472 to Hans D. Baumann (2003) discloses an improved plug in a control valve, but the conventional joint between the plug and the stem eliminates all freedom and is unable to compensate any misalignment between the stem and the plug, the misalignment is a main cause for high leakage and friction.

For a century, the fluid control industries have made tremendous efforts to solve problems related to metal to metal seal, although there are many seal structures, simply they can be classified into two groups; static and dynamic, the focus on this invention is on the dynamic seal, but the benefits of invention can be applied to static seal as well. The dynamic seal is provided with a seal between a moving part and a stationary part in all fluid related products, a movement between the two parts can be rotary, linear or combination of linear and rotary, and the linear movement can be parallel or perpendicular. The moving part can be a valve member in a fluid related product, while the stational part can be a body or housing in the fluid related product. So far for linear metal to metal seals in the gate valve, engine valve, fuel injector, need valve, or control valve, the solution is a rigid surface vs. a rigid surface seal, this seal is workable, but this seal is accomplished either by expensive surface processes such as lapping, polishing or by welding expensive hard materials to seal surfaces, this solution still is not satisfying in terms of efficiency, life, reliability and cost.

On the other hand, rotary metal-to-metal seals in butterfly valves or ball valve are much more challenging due to the nature of rotation mechanism, the conventional solutions are; (a) A rigid surface vs. a line seal which is a solid seat such as a disc or a body against a seal ring having a line contact seal and two floating ends (b) A rigid surface vs. a line seal which is a solid surface such as a disc or body against a seal ring having one line seal and one support end (c) A rigid surface vs. a multiple lines seal which is a solid seat as disc or body against a laminated seal ring. The disadvantages of those seals are obvious, first those seals are unable to compensate any offset between the moving part and stationary part, second the rigid surface vs. the line seal with one end support or two floating ends is unreliable and unstable under high pressure, high temperature and high cycle environments, third the rigid surface vs. the multiple lines seal generates a very high torque, above all, metal to metal seals still have not reached the level of the resilient seal in terms of sealability.

In short, the prior arts in the seat seal have common disadvantages;

(1) Static seat seal is misused for dynamic seat seal applications. Most seat seal assemblies comprise two parts of seal, one seal is disposed on a valve body which is stationary, and other seal is disposed on a valve member which is movable. So far the radial laminated seat seal rings as one of the seals in all the prior arts provide the best seal, but they all have at least one rigid solid surface seal either on the valve body or valve member, so none of them can compensate any dynamic offset between the valve body and the valve member when valve member is moving, moreover the laminated seal ring against the rigid solid seal surface has higher operation forces or torques and is vulnerable to any seal surface damage or fluid contaminations.
(2) High energy consumption. The conventional approach to solve high erosion, abrasion or friction on the seat seal, the valve body and the valve member is to employ expensive, harder materials. The erosion, abrasion and wearing are all caused by energy exchange between different matters, the difference is that the friction which happens between two solid matters, while the erosion, abrasion which happen between solid matters and fluid matters, so if the energy can be stored instead of dissipation, the seat seal can last much longer, the conventional seat seal with the laminated seal ring against the rigid solid seat can not store much energy, so any energy loss can damage either the seat seal or the valve body and valve member, because energy can not be destroyed or created.
(3) Misalignment. In real world, the two parts of the seat seal assembly are never perfectly matched. There is no mechanism to adjust a misalignment in the most prior arts, the premature wearing and leakage of the seat seal assembly are caused by misalignment between the two parts of seals, most of leakage on butterfly valve or ball valve happen at the four quadrant points of seat seal rings, for the reciprocal control valve, the premature wearing and leakage happen between a plug and sleeve or plug and seat.

In aspect of the mechanical assembly structures, U.S. Pat. No. 4,483,513 to Anthony C. Summers (1984) and U.S. Pat. No. 4,828,221 to William B. Scobie (1998) disclose improved joints between a stem and a valve member, but the disadvantage is that the joints eliminate the stem axial freedom, the elimination can force thermal expansion to damage a seat or cause the stem deformation and a seat leak under high temperature, a conventional solution to the problem is to employ a key joint as shown in U.S. Pat. No. 6,079,695 to Jerry Gassaway (2000), but the key joint weakens the two hubs where the highest stress and stress concentration are located and torques are unevenly transferred, moreover the key joint requires an expensive broaching process for keyway. U.S. Pat. No. 6,029,949 to Robert Joseph Brown et al (2000) shows a plate and bolts for securing a stem on a vane, the design with the plate and bolts can further weakens the stem and vane and adds the cost for materials as well as machining, and there is a high risk of the plate and bolts falling into a pipeline system under high temperatures or high vibration conditions, such a design is prohibited in the turbine and engine systems. U.S. Pat. No. 5,277,404 to C. Steven Anderson (1994) discloses other joint means for a ball valve, the joint means for a ball and stem reduces wearing, but the stem is still under side loading which can cause a stem leak, the joint is expensive to produce, in addition the seat with the spilt bodies has no adjustable mechanism for controlling distance between the seat and the ball and requires precision machining and assembly.

Finally a conventional mechanical joint means for retaining a seat seal assembly on a valve member or body is accomplished by a retaining ring and multiple bolts as shown in U.S. Pat. No. 6,079,695 to Jerry Gassaway (2000), such a mechanical joint means requires precision drilling and tapping as well as tedious bolting process, any uneven bolting by manual operation or other process can cause a seat leak and heavy seating and unseating torques specially in large size valves or in high temperature environments, more importantly this mechanical joint means has a high risk of bolts falling into a pipeline system and is prohibited for using in the engines and turbines or other highly vibrated conditions, so a more reliable retaining device was developed as shown in U.S. Pat. No. 5,692,725 to Hans-Jurgen Fehringer (1997), the retaining device has smaller operating holes which prevents screws or bolts falling into a pipeline system, but the complicated retaining ring can be used only on a stationary body and not on a movable valve member, such a retaining device does not have a self lock or point force amplifying mechanism, so any reaction force by a high vibration or uneven point forces by screws or bolts can cause screws loose and a seat leak.

So the fluid control valve industry has long sought means of improving the performance of fluid control system under extreme fluid conditions, reducing the stem and seat leakage, cost for production and operation, increasing reliability and efficiency and accuracy of control and life of fluid control system.

In conclusion, insofar as I am aware, no fluid control system formerly developed provides high performances with a modularization structure, less energy loss, high efficiency, versatile, reliable seals, simple structure, and easy manufacturing at low cost.

### SUMMARY

This invention provides a fluid control system based on novel flow control mechanisms, seal technologies and mechanical structure assemblies for regulating flow fluid under extreme conditions. This system comprises two basic modules; a reciprocal control module and rotary control module. The reciprocal control module can be constructed as a control valve, engine valve, metering valve, and needle valve, while the rotary control module can be constructed as a butterfly and ball valve. This fluid control system provides novel energy transmission devices to regulate a flow fluid rate and flow fluid pressure in different manners with minimum energy loss consequences. This system also has dynamic seal assemblies for stem seals and seat seals. The dynamic stem seal assembly is simple, reliable and safe and has an inclusive packing and controllable loading device with a stem leakage between 10-500 ppm. The dynamic seat seal assembly comprises a body seal assembly and valve member seal for compensating any offset between a valve body and a valve member, the dynamic seat seal assembly is provided with zero leakage and novel mapped solutions with five basic geometric seal elements, the metal to metal seal has reached the ultimate goal-a pointed, robust and reliable tight seal and lower torque even under extreme fluid conditions. The mechanical structure assemblies provide a number of novel stem joint features; a dual-centers stem joint is simple and reliable and will have the most profound impact on rotary stem joints or coupling field and has broad applications such as coupling, pump, motor, engine, compressor and automobile and tools.

The energy transmission devices comprise two types; energy storage and energy consumption. The energy transmission device for the energy storage is used for regulating flow fluid rates and comprises a frame assembly having spiral winding wires and acts as a medium for storing and releasing fluid energy by deflection and vibration of the wires among fluid molecules as well as generating vortexes around the wires at stage of throttling or vena contracta. The energy transmission devices for the energy consumption is used for regulating flow fluid pressures and comprises a stacked ring assembly having spiral winded wires and sandwiched by separating plates, gaps between section of winded wires and the plates create flow paths and contact surfaces for converting the fluid energy in the most efficient and optimal way. Finally the flow fluid through the energy transmission devices is divided into two streams of the fluid and converges to one fluid stream before leaving the fluid control device and converting the kinetic energy back to potential energy.

The dynamic stem seal assembly comprises a stem packing and a bore packing and a secondary seal. The stem packing is installed on a stem, while the bore packing is installed in a packing support. When the stem is moving, the stem packing is attached to the stem while the bore packing is attached to the packing support or packing bore, so the two packing sets can compensate any offset between the stem and the packing support. The stem packing comprises a metal ring and a non metal ring, the metal ring can be constructed as single ring or spiral spring ring with various cross section shapes, such as rectangle, cycle, V, delta, U, O, H and S, the non-metal materials are made out of graphite, PTFE or other plastics or rubber. The spiral spring ring is the most efficiently device to store energy to help radial seal and can be used for both rotary and reciprocal stems. The secondary stem seal is provided as a floating stem seal, the floating stem seal in the rotary valve can be attached to either a stem or packing support for compensating any offset between the stem and packing support when the stem is rotated, while the floating seal in the reciprocal valve is attached to a packing support for compensating any offset between the stem and the packing support.

Finally the dynamic stem seal assembly is provided with controllable loading screws for the bore packing, circumferential screws with conical tips are engaged with a conical gland for converting circumferential movements to axial movements and pressing the bore packing with a limit compression force, moreover the loading screws and bore packing are inclusive in the packing support, any mass stem leakage can be easily contained by an actuator or handle with a cover plate or other device.

The dynamic seat seal assembly provides a bobble tight metal seal and comprises the body seal assembly installed on the valve body and the valve member seal installed on the valve member for compensating any offset. The seal ring can be defined as one of the five basic geometric seal elements, the five geometric seal elements are point seal, line-point seal, line seal, flexible surface seal and rigid solid surface seal, the combinations of the five geometric seal elements has been mapped with over 25 seal solutions, the ultimate seal goal for metal to metal seal has finally reach with a point vs. point seal. The profiles of seal surfaces can be spherical, conical, wedge and other mating surfaces. Those solutions not only reduce seating and unseating forces and leakage, but also improve the seat seal performances in terms of reliability, stability, versatility, simplicity and adaptability.

Accordingly, besides objects and advantages of the present invention described in the above patent, several objects and advantages of the present invention are:
(a) To provide a fluid control system with an energy storing and balance mechanism for regulating flow rate, so such a system not only saves fluid energy but also minimizes the consequence of any energy loss such as noise, vibration, cavitations and erosion.
(b) To provide a fluid control system with the most efficient fluid energy converting mechanism for regulating fluid pressure, so such a system not only uses simple structure for dissipating fluid energy or converting fluid energy to other useful energy forms, but also minimizes the consequence of any energy loss such as noise, vibration, cavitations and erosion.
(c) To provide a fluid control system with a stem seal assembly having efficient energy storing mechanisms for minimizing friction between a stem and a packing. So such a system can reduce wearing and operation power as well as improve seal.
(d) To provide a simple stem joint means for transmitting torque or rotary motion. Such a joint means can be connected or disconnected easily and is reliable and robust with less stress concentration, no backlash and simple manufacturing.
(e) To provide a fluid control system with a dynamic stem seal, such a dynamic stem seal is simple and reliable with offset compensation as the stem is moving.
(f) To provide a stem seal assembly with an inclusive packing and overloading protection. Such a stem seal assembly has a loading limit mechanism and is containable in case of emergency or mass leak.
(g) To provide a stem seal assembly for extreme conditions: high pressure, cryogenic or high temperature or fire-safe applications. Such an assembly can keep a good seal as well as lower leakage between 10-500 ppm.
(h) To provide a simple and reliable joint between a stem and a valve member. Such a joint provides with optimization of stress distribution with less material and machining but still has high strengths and reliability under high temperature, high pressure or high vibration environment.
(i) To provide mapped seal solutions for all metal to metal seal applications. Such solutions have reliable seal and offer various solutions for different applications.
(j) To provide a reliable mechanical joint device for joint tow parts securely. Such a retaining device has a wedge mechanism, a self-lock angle and a mechanism for preventing any screw, or locking rings from falling into a pipeline system.
(k) To provide a material adding process to seal surfaces of a fluid control system. Such a process not only improves seal surface quality and life under high corrosive, abrasive fluid conditions, but also reduces the production cost and friction.
(l) To provide a seat seal assembly with various seal geometric elements. The combinations of seal geometric elements can be constructed with thin ring or wire, so the seat seal device has high strength and high flexible surface with lower operation forces and friction.
(m) To provide seal assembles for engines, so the engine can have higher fuel efficiency with lower leakage, friction and cost.
(n) To provide a metering valve or fuel injection device for engines, so the engines have stable metering performance and higher fuel efficiency with low cost.
(o) To provide a fluid control system with a valve member having a low energy consumption for high velocity, high erosive or high abrasive applications. Such a valve member can be constructed with different flow patterns and simple, reliable structure.
(p) To provide a device for adjusting misalignment between a seat and seal ring or body and valve member. Such a device can be easily access and reduce wearing and torque.
(q) To provide a secure device for securing a seat seal assembly against a valve body or a valve member. Such a secure device has simple adjustable mechanism and only eliminates an axial freedom with circumferential freedoms.
(r) To provide a fluid control system with highly reliable, inherently redundant, intrinsically safe means, so the system can be used for critical applications such as military operation, medical emergence care, and aircraft.
(s) To provide a produced-friendly, fluid control system with simple, flexible module structures, easy production and various material selections. So the modules require only simple manufacturing process and flexible construction methods for different applications and sizes and a manufacturer for the system can easily implement rapid product development and outsourcing at lower cost.

Still further objects and advantages will become apparent from study of the following description and the accompanying drawings.

### DRAWINGS

### Drawing Figures

FIG. A1 is an explored, perspective, partially cut-away view of a control valve constructed in accordance with this invention.

FIG. A2 is a front cross sectional view of the control valve constructed in accordance with this invention.

FIG. A3 is a top cross sectional view of the control valve shown constructed in accordance with this invention.

FIG. A4 is an enlarged sectional view of the sleeve seal assembly of FIG. A2.

FIG. A5 is an enlarged sectional view of middle area of FIG. A2.

FIG. A6 is an enlarged sectional view of the stem seal assembly of FIG. A2.

FIG. A7 is an enlarged sectional view of upper left area of FIG. A2.

FIG. A8 is an enlarged sectional view of lower left area of FIG. A2.

FIG. A9 is an enlarged sectional view of lower left area of FIG. A2.

FIG. A10 is an enlarged sectional view of the seat seal assembly of FIG. A2.

FIG. A11 is a perspective view of the energy transmission device of middle area of FIG. A2.

FIG. A12 is a perspective view of a frame shown in FIG. A11.

FIG. A13 is a perspective view of the energy transmission device with the alternative winding shown in FIG. A11.

FIG. A14 is a perspective view of the alternative energy transmission device shown in FIG. A11.

FIG. A15 is a perspective view of the ring having winded wires shown in FIG. A14.

FIG. A16 is a perspective view of the ring shown in FIG. A15.

FIG. A 17 is a perspective, partial cross sectional view of the alternative energy transmission device shown in FIG. A11.

FIG. A18 is a perspective view of the frame shown in FIG. A17.

FIG. A19 is a perspective view of the alternative frame shown in FIG. A18.

FIG. A20 is a perspective view of the alternative energy transmission device shown in FIG. A17.

FIG. A21 is a perspective view of the ring having winded wires shown in FIG. A20.

FIG. A22 is a perspective view of the separating plate shown in FIG. A20.

FIG. A23 is a perspective, partial cross sectional view of the alternative plug and the alternative seat seal assembly shown in FIG. A2.

FIG. A24 is a front cross sectional view of the alternative plug and the alternative seat seal assembly shown in FIG. A23.

FIG. A25 is an enlarged sectional view of the alternative seat seal assembly of FIG. A24.

FIG. A26 is a sectional view of the alternative valve shown in FIG. A2.

FIG. A27 is a sectional view of the alternative valve shown in FIG. A2.

FIG. B1 is an explored, perspective, partially cut-away view of a butterfly valve constructed in accordance with this invention.

FIG. B2 is a front view of the butterfly valve constructed in accordance with this invention.

FIG. B3 is a cross sectional view of the butterfly valve of FIG. B2 along line J-J.

FIG. B4 is a cross sectional view of the butterfly valve of FIG. B2 along line H-H.

FIG. B5 is a cross sectional view of the butterfly valve of FIG. B2 along line K-K.

FIG. B6 is a cross sectional view of the butterfly valve of FIG. B2 along line M-M.

FIG. B7 is an enlarged sectional view of upper area of FIG. B4.

FIG. B8 is an enlarged sectional view of lower area of FIG. B4.

FIG. B9 is an enlarged sectional view of the stem seal assembly of FIG. B4.

FIG. B10 is an enlarged sectional view of the disc retaining ring of FIG. B3.

FIG. B11 is an enlarged sectional view of the body retaining ring of FIG. B3.

FIG. B12 is an enlarged sectional view of the seat seal assembly of FIG. B4.

FIG. B13 is a partial sectional view of the alternative stem seal assemblies shown in FIG. B9.

FIG. B14 is an enlarged, perspective, partial cross sectional view of the alternative stem joint shown in FIG. B1.

FIG. B15 is a partial sectional view of the alternative seal ring unit shown in FIG. B12.

FIG. B16 is a cross sectional view of the alternative seat seal assembly shown in FIG. B12.

FIG. B17 is a partially cross sectional view of the alternative seat seal assemblies shown in FIG. B12.

FIG. B18 is a partially cross sectional view of the alternative seat seal assembly shown in FIG. B12

FIG. B19 is a partially cross sectional view of the alternative seat seal assemblies shown in FIG. B12.

FIG. C1 is an explored, perspective, partially cut-away view of a ball valve constructed in accordance with this invention.

FIG. C2 is a front cross sectional view of the ball valve constructed in accordance with this invention.

FIG. C3 is an enlarged view of the stem joint shown in FIG. C1.

FIG. C4 is an enlarged sectional view of lower area shown in FIG. C2.

FIG. C5 is an enlarged cross sectional view of the stem seal assembly of FIG. C2.

FIG. C6 is an enlarged cross sectional view of the secondary stem seal assembly shown in FIG. C2.

FIG. C7 is a top cross sectional view of the ball valve constructed in accordance with this invention.

FIG. C8 is an enlarged view of a ball retaining ring shown in FIG. C2.

FIG. C9 is a perspective, partially cut-away view of the ball with the energy transmission device shown in FIG. C1.

FIG. C10 is an enlarged cross sectional view of the seat retaining ring shown in FIG. C7.

FIG. C1 is an enlarged cross sectional view of the body retaining ring shown in FIG. C7.

FIG. C12 is an enlarged cross sectional view of the seat seal assembly shown in FIG. C2.

FIG. C13 is a partial cross sectional view of the alternative seal ring unit shown in FIG. C12.

FIG. C14 is a perspective, partially cut-away view of the alternative stem adaptor shown in FIG. C3.

### REFERENCE NUMBER IN DRAWING

| | |
|---|---|
| 100 | Control Valve |
| 102 | body a, b, c |
| 104 | port a, b |
| 106 | axial bore a, b, c |
| 108 | seat |
| 110 | groove a, b, c |
| 114 | recess |
| 116 | surface a, b, c |
| 118 | chamber a, b , c |
| 120 | stem |
| 122 | groove a, b |
| 124 | hole |
| 125 | bearing |
| 126 | Lock block |
| 127 | surface |
| 128 | thread hole |
| 130 | stem seal assembly |
| 131 | packing a, b |
| 132 | ring a, b, c |
| 134 | gland |
| 134a | gland surface |
| 134b | hole |
| 135 | packing support, bonnet |
| 136 | bore a, b, c |
| 137 | recess |
| 138 | surface |
| 140 | sleeve |
| 141 | recess a, b |
| 142 | surface a, b |
| 143 | hole |
| 144 | secondary stem seal |
| 144a | surface |
| 146 | plug seal assembly |
| 147 | seal ring |
| 148 | screw a, b, c |
| 150 | valve member, plug |
| | a, b, c, d |
| 152 | access slot |
| 154 | bore a, , c, |
| 154b | recess |
| 156 | hole a, b, c, d, e, f, g |
| 158 | release hole a, b |
| 160 | recess a, b, c, d, e |
| 162 | thread hole |
| 164 | groove a, b, c, d, e, f, g |
| 166 | surface a, b, c |
| 167 | slot |
| 168 | cover |
| 168a | boss |
| 168b | cap |
| 168c | thread hole |
| 169 | snap ring |
| 170 | seat seal assembly a, b, c, d |
| 170 | body seal and valve member seal |
| 171 | seal ring unit a, b, c |
| 172 | seal surface seal ring a |
| 173 | surface a, b, c |
| 174 | ring a, b, c, d, e, f |
| 176 | surface a, b |
| 178 | section a, b, c |
| 180 | retaining ring a, b, c, d |
| 181 | thread hole |
| 182 | hole |
| 183 | surface a, b, c |
| 184 | gasket a, b, c, d |
| 185 | groove a |
| 186 | lock ring |
| 187 | surface a, b |
| 188 | screw |
| 189 | surface |
| 190 | energy transmission device a, b, c, d |
| 192 | frame a, b, c |
| 193 | ring section a, b, c |
| 194 | rib section a, b |
| 195 | ring |
| 196 | wire |
| 197 | plate |
| 200 | butterfly valve |
| 202 | body |
| 204 | passage |
| 206 | axial bore a, b, c |
| 207 | packing support, neck |
| 210 | groove |
| 214 | recess a, b , c |
| 216 | surface a, b, c |
| 218 | chamber a, b |
| 219 | hole |
| 220 | stem |
| 222 | keyway a, b |
| 224 | section a, b, c |
| 226 | clamp ring |
| 227 | bearing a, b |
| 228 | stem adaptor |
| 229 | section a, b, c |
| 230 | stem seal assembly |
| 231 | packing a, b |
| 232 | ring a, b |
| 233 | section a, b, c |
| 234 | gland |
| 234a | gland surface |
| 236 | position ring |
| 236a | groove |
| 236b | keyway |
| 236c | stem hole |
| 236d | surface |
| 238 | key a, b |
| 240 | thrust bearing |
| 240a | wedged slot |
| 240b | surface |
| 242 | wedge |
| 242a | T slot |
| 242b | surface |
| 242c | surface |
| 244 | secondary seal |
| 245 | ring a, b, c |
| 246 | surface a, b |
| 249 | position screw a, b, c, d |
| 250 | valve member, disc |
| 252 | disc portion |
| 254 | hub a, b |
| 256 | stem hole |
| 258 | key holder a, b |
| 260 | keyway a, b |
| 262 | recess a, b |
| 264 | thread hole |
| 268 | cavity |
| 269 | surface a, b, c |
| 270 | seat seal assembly |
| 270 | body seal and valve member seal |
| 271 | seal ring unit a, b |
| 272 | surface seal ring a, b |
| 273 | surface a, b, c, d |
| 274 | ring a, b, c, d |
| 275 | ring form a, b |
| 276 | surface a, b |
| 278 | section a, b, c, e, f, g |
| 280 | retaining ring a, b |
| 281 | groove a, b |
| 282 | groove a, b |
| 283 | hole a |
| 284 | surface a, b |
| 285 | slot |
| 286 | lock ring a, b |
| 287 | T-slot |
| 288 | surface a |
| 290 | screw a, b |
| 292 | T screw |
| 294 | gasket a, b |
| 300 | ball valve |
| 302 | body |
| 304 | passage |
| 306 | axial bore a, b, c |
| 310 | groove |
| 312 | hole |
| 314 | recess |
| 316 | surface a, b, |
| 318 | chamber a, b, c |
| 319 | section a, b |
| 320 | stem |
| 322 | section a, b, c, e, f, g |
| 324 | hole |
| 326 | ring |
| 327 | stem adaptor a, b |
| 328 | section a, b, c, d, e |
| 330 | stem seal assembly |
| 331 | packing a, b |
| 332 | ring a, b, c |
| 334 | gland, packing support |
| 334a | surface |
| 334b | groove |
| 334c | bore |
| 334d | bore |
| 334e | recess |
| 336 | thrust stem |
| 336a | groove |
| 336b | hole |
| 336c | axis |
| 338 | thrust bearing |
| 338a | boss |
| 338b | hole |
| 338c | hole |
| 338d | hole |
| 340 | nut |
| 342 | pin |
| 344 | secondary stem seal |
| 345 | ring a, b, c |
| 346 | surface a, b |
| 349 | screw a, b, c |
| 350 | valve member, ball |
| 352 | port |
| 354 | upper bore a, b, c, |
| 356 | lower bore |
| 358 | groove a |
| 359 | slot |
| 362 | recess a, b |
| 364 | thread hole |
| 366 | groove a, b |
| 368 | cavity |
| 369 | surface a, b, c |
| 370 | seat seal assembly a, b |
| 370 | body seal and valve member seal |
| 371 | seal ring unit a, b |
| 372 | surface seal ring a |
| 373 | surface a, b |
| 374 | ring a, b, c, d |
| 375 | ring form a, b |
| 376 | surface a, b |
| 378 | section a, b, c |
| 380 | body retaining ring |
| 380a | groove |
| 380b | hole |
| 380c | hole |
| 380d | surface |
| 380e | surface |
| 380f | groove |
| 380g | surface |
| 380h | port |
| 380k | recess |
| 380m | recess |
| 380n | recess |
| 380p | recess |
| 380s | recess |
| 382 | ball retaining ring |
| 382a | groove |
| 382b | slot |
| 382c | surface |
| 384 | seat retaining ring |
| 384a | groove |
| 384b | hole |
| 384c | surface |
| 384d | bore |
| 384e | bore |
| 386 | Body lock ring |
| 386a | bore |
| 386b | surface |
| 388 | Ball lock ring |
| 388a | surface |
| 390 | screw |
| 390a | hex shoulder |
| 391 | nut |
| 392 | screw |
| 392a | head |
| 392b | surface |
| 394 | gasket a, b, c |

### DESCRIPTION

### Control Valve

FIGS. A1-A27 illustrate a control valve 100 constructed in accordance with the present invention. The control valve 100 comprises a body 102a having fluid ports 104a and 104b. A valve member or plug 150a is disposed in body 102a by means of a sleeve 140 and a stem 120 for movement between open and closed positions and regulating flow fluid between port 104a and port 104b. Stem 120 is typically coupled with an actuator (not shown) for moving plug 150a. A stem seal assembly 130 is disposed between a packing support or bonnet 135 and stem 120 for preventing fluid leak through a stem bore 136c. A seat seal assembly 170a is provided for sealing between body 102a and plug 150a when plug 150a is in a closed position. An energy transmission device 190a is provided for storing and releasing fluid energy with minimum energy loss.

Referring now to FIGS. A1-A3, the plug 150a is movably disposed in sleeve 140 with a clearance fit for regulating flow fluid between ports 104a and 104b. Two release holes 158a are provided to balance a fluid pressure difference between chambers 118a and 118c. Sleeve 140 is disposed in a bore 106b and has a recess 141b for receiving and securing energy transmission device 190a and a plurality of fluid holes 143 for fluid communications between chamber 118a and chamber 118b when plug 150a is moving away from a seat 108. Fluid holes 143 equally spanned are divided into two group in an opposite direction and located circumferentially away from port 104b for splitting an incoming fluid steam from port 104a into two fluid streams in a recess 114 and converting the two fluid streams into one fluid steam in port 104b, such counter-balanced fluid stream mechanism not only depresses cavitations, but also saves the fluid energy. Stem 120 is coupled with plug 150a for transmitting forces or movements to plug 150a. An annular gland 134 disposed in a bore 136a has a bottom surface urged on top of a packing 131a, said gland has a hole 134b receiving stem 120 and a conical surface 134a with a rough texture or a friction induction texture, two control screws 148a threaded through bonnet 135 have conical tips engaging with conical surface 134a of gland 134 for securing gland 134 and controlling loads on packing 131a, an angle of the conical surface 134a is the same as an angle of conical tip of screw 148a, additional screws 148a may be needed for securing the gland 134 and the control screws 148a.

Referring now to FIG. A4, a plug seal assembly 146 is provided for sealing between chamber 118c and chamber 118b when plug 150a is in a closed position. Plug seal assembly 146 comprises a spiral spring ring 147 and a gasket 184d which are disposed in a groove 164b. The gasket 184d is made out of heat resisted and cryogenic-stable, relatively flexible materials such as graphite, reinforced PTFE and soft metal, while ring 147 is made out of heat resisted and cryogenic-stable spring materials, such as spring stainless steel, or spring stainless steel with PTFE coating. A shape of cross section of ring 147 may be rectangle, round or others.

Referring now to FIGS. A3 and A5, the stem 120 is disposed in a bore 154a with a clearance fit. Stem 120 has a O-ring profile groove 122b, each of two lock blocks 126 has O-ring profile surface 127 which is engaged with surfaces 122b of stem 120 in opposite directions for transmitting axial movements or forces between plug 150a and stem 120, the profile of surface 127 is the same as the profile of the groove 122b, the plug has 150a has a groove 164a for receiving blocks 126. Each of blocks 126 has a thread hole 128 and a screws 148b for preventing any relative movement between stem 120 and plug 150a in an axial direction. The screw 148b has a first end threaded into hole 128 and a second end urged on groove 164a for preventing any relative movement between stem 120 and plug 150a in an axial direction Two smaller, axial access bores 154c on the plug 150a are provided for preventing locking screws 148b from falling out and for operating screws 148b. Two access slots 152 on plug 150a are provided for assembling or disassembling lock blocks 126 into and from groove 164a.

Referring now to FIGS. A2 and A6, the stem seal assembly 130 is disposed between bonnet 135 and stem 120. Stem seal assembly 130 comprises a bore packing 131a, a stem packing 131b, and a secondary stem seal 144. The bore packing 131a disposed in bore 136a comprises a plurality of delta rings 132a, ring 132a is made out of heat resisted and cryogenic-stable, relatively flexible materials such as graphite, reinforced PTFE and soft metal. The stem packing 131b disposed in a groove 122a comprises a graphite ring 132c having rectangle cross-section and a spiral spring ring 132b. Spring ring 132b is provided with one end inserted into a hole 124 for preventing relative movement between stem 120 and ring 132b shown in FIG. A1. A shape of cross section of spring ring 132b may be rectangle, round or others, ring 132b is made out of heat resisted and cryogenic-stable, spring materials such as a spring stainless steel, or spring stainless steel with PTFE coating or cover. When stem 120 has a relative movement against bonnet 135, the packing 131a is attached to bonnet 135, while packing 131b is attached to stem 120, there is no relative movement between packing 131a and bonnet 135, or packing 131b and stem 120, so both packings 131a, 131b can compensate any offset between stem 120 and bore 136a when stem 120 is moving.

The secondary stem seal 144 is disposed between a bore 136b and stem 120 and is urged against a conical bottom of bearing 125, an internal surface 144a is provided for seals between steml20 and bearing 125, stem 120 and bore 136b. When stem 120 is moving, seal 144 not only compensates any offset between stem 120 and bore 136b, but also prevents any solid material from getting into stem seal assembly 130.

Referring now to FIGS. A2 and A7, seals are provided between bonnet 135 and body 102a, bonnet 135 and sleeve 140. A graphite gasket 184c is disposed between a recess 137 and a bore 106a defined by a surface 116a, while sleeve 140 is provided with a recess 141a defined by a conical surface 142a which is urged against a conical surface 138, a profile of conical surfaces 138 is the same as a profile of conical surfaces 142a.

Referring now to FIGS. A2 and A8, plug 150a has a recess 154b receiving a retaining ring 180a with a transitional fit. Retaining ring 180a is provided with a surface 183a to secure a flexible surface seal ring 172a and a groove 164c with a conical surface 166a defined by an angle. Retaining ring 180a also has three circumferential thread holes 181 extending to three smaller access holes 182. Each of three screws 188 is threaded into thread hole 181 and is provided with a conical surface 189 engaged with conical surface 166a. An angle of conical surface 166a is the same as that of surface 189 and smaller than a self-lock angle. Conical surface 166a constructed with a rough surface texture or a friction induction texture and the three smaller access holes 182 is provide for preventing screws 188 from loosing and falling out.

Referring to FIGS. A2 and A9, an annular lock ring 186 is disposed in a groove 110b with a conical surface 116c defined by an angle for securing a point seal ring unit 171a. Lock ring 186 is constructed as three segments with two conical surfaces 187a and 187b defined respectively by two angles. The conical surface 187b is urged against surface 116c. The angle of surface 187b is substantially the same as that of surface 116c and smaller than a self-lock angle. Sleeve 140 has a conical surface 142b engaged with conical surfaces 187a. An angle of conical surface 142b is substantially the same as that of surface 187a.

Referring to FIG. A10, seat seal assembly 170a comprises a body seal assembly, or point seal ring unit 171a and a valve member seal assembly or flexible surface seal ring 172a. Plug 150a has a recess 160a defined by a surface 166b, a recess 160b receiving seal ring 172a and a groove 164d receiving a gasket 184b for a seal between surface 166b and seal ring 172a, while body 102a has the seat 108 receiving seal ring unit 171a and a groove 110a receiving a gasket 184a for a seal between a surface 116b and seal ring unit 171a. A peripheral seal surface 173a of seal ring 172a is engaged with a peripheral seal surface 173b of seal ring unit 171a for forming a point/flexible surface sealing between chamber 118b and chamber 118a, a profile of surface of 173a is substantially the same as that of surface 173b and can be spherical or conical and other mating shapes.

The point seal ring unit 171a comprises two outmost metal holding rings 174a and multiple middle point rings 174b, seal ring unit 171a also comprises two conical back rings 174c, 174d, metal back ring 174d has a little bit smaller inside diameter than outside diameter of seal rings unit 171a, so graphite back ring 174c supported by metal back ring 174d generates a compression between a conical surface 176a of seal ring unit 171a and a surface 176b of back ring 174c for preventing fluid seeping among rings 174a and 174b, the middle point rings 174b are constructed with a plurality of wires which are made out of heat resisted and cryogenic-stable, flexible materials such as stainless steel. The seal surface 173b of middle point rings 174b is defined by plurality of rectangle cross-section of wires. The area of cross sections is between 0.007-0.011 square inches (0.46-7.4 square mm).

The flexible surface seal ring 172a is constructed as a half-H ring having a seal surface section 178b, a support section 178a to be fixed and a floating section 178c to be floated. A thickness of ring 172a is between 0.01 and 0.18 inch (0.25-4.5 mm). Seal ring 172a may be made out of metal or metal with anti-corrosive, abrasive coatings or base metal having deposed material with thickness between 0.005-0.020 inches (0.12-0.5 mm). The deposing process is accomplished by thermal spray such as High Velocity Oxygen Fuel (HVOF).

Referring to FIGS. A11, A12 and A13, the energy transmission device 190a is provided to store and release fluid energy when plug 150a is used for regulating flow fluid rate between ports 104a and 104b. The device 190a comprises a rigid frame assembly 192a having two cylindrical ring sections 193a and two rib sections 194a connected to sections 193a, a flexible wire 196 with cross section area between 0.0007 and 0.0288 square inches (0.45-18 square mm) is winded on frame 192a with gaps between 0.03-1.00 inch (0.76-25.4 mm) as shown in FIGS. A12 and A13 or other manners for contacting and directing flow fluid. Flexible sections of wire 196 are provided to store and release flow fluid energy by vibration, since the flow fluid is not continuous, there are voids among fluid molecules, segments of wires 196 are constantly vibrated among fluid molecules as medias for transferring energy between fluid molecules instead of conventional direct energy exchange among fluid molecules between potential energy and kinetic energy, the segments of wires 196 as solid elements in the fluid energy exchange not only prevent cavitations by controlling distance of fluid molecules, but also saves fluid energy by storing and releasing energy. For high flow fluid rate applications, a plurality of energy transmission device 190a may be installed in coaxial manners.

Referring to FIGS. A14, A15 and A16, an energy transmission device 190b is installed when valve 100 is used for regulating flow fluid pressure. The energy transmission device 190b comprises a stacked frame assembly including a plurality of rigid rings 195 which are stacked in a coaxial manner and have less flexible, winded wires 196, wire 196 is made out of a plurality of materials such metals, plastics, rubbers or others, the device 190b is provided with gaps between 0.03-1.00 inch (0.76-25.4 mm) among sections of wires 196 and between rings 195, the gaps create maxim fluid contact surfaces and length of flow paths for dissipating fluid energy through energy exchange between device 190b and the flow fluid. Since device 190b is an energy consumption device, consumed energy in device 190b is changed to other forms of energy such as, heat energy, mechanical energy or electric energy, wires 196 may be made out of good heat conduct materials for quick heat energy release. For larger device 190b a series of bolts or other types of mechanical fasteners may be used to securely maintain the stacked device 190b. For applications where device 190b is used as a standalone product such as diffuser, silencers or for high flow rate application, stacked device 190b may be point-welded together.

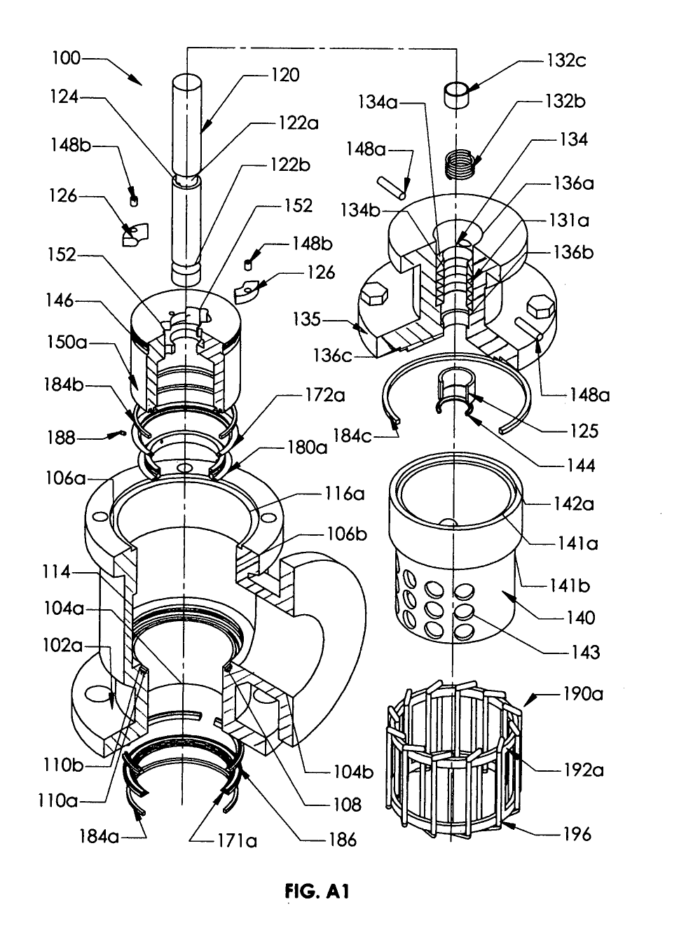

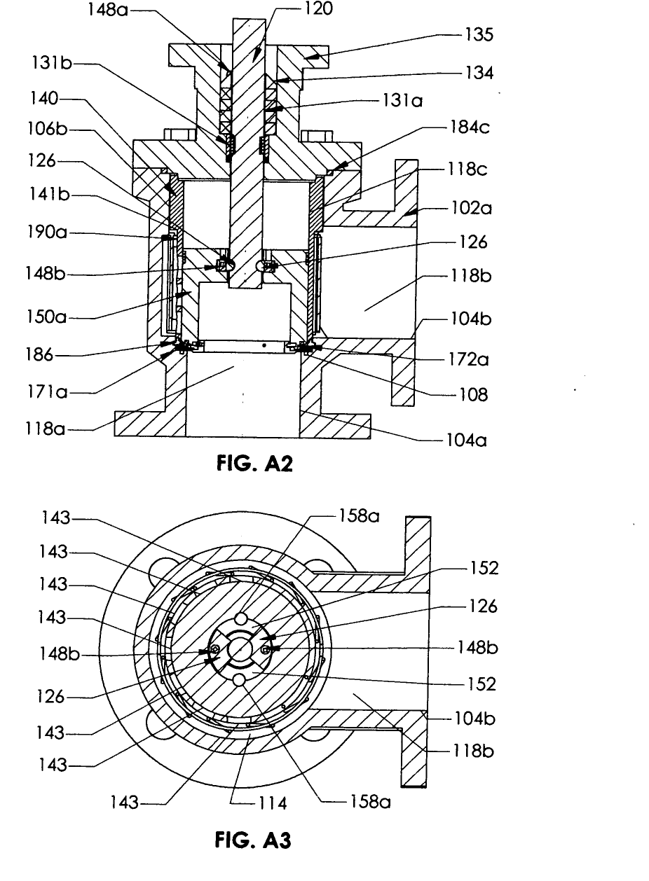

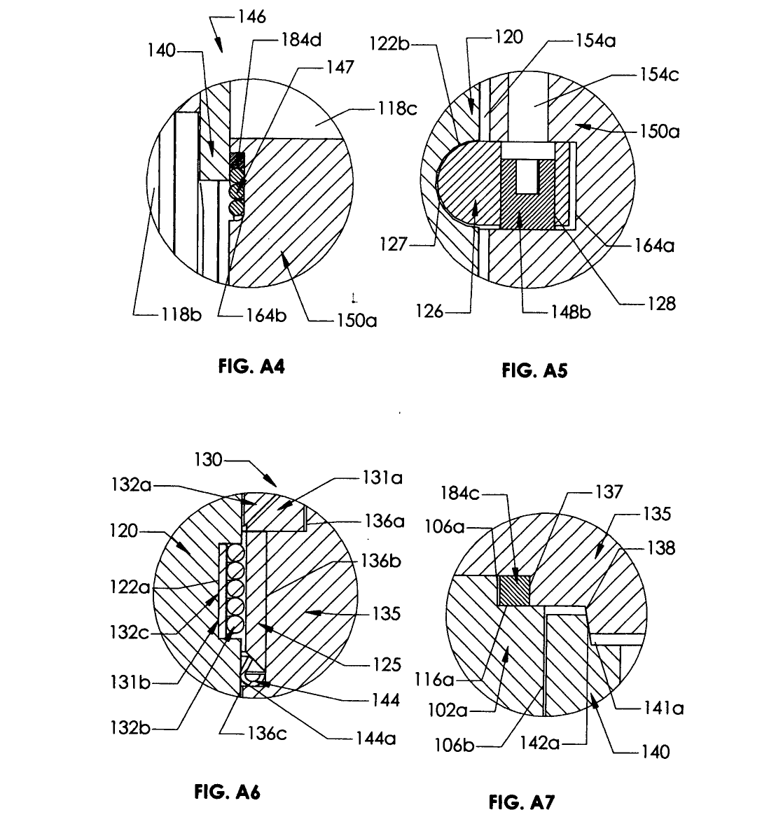

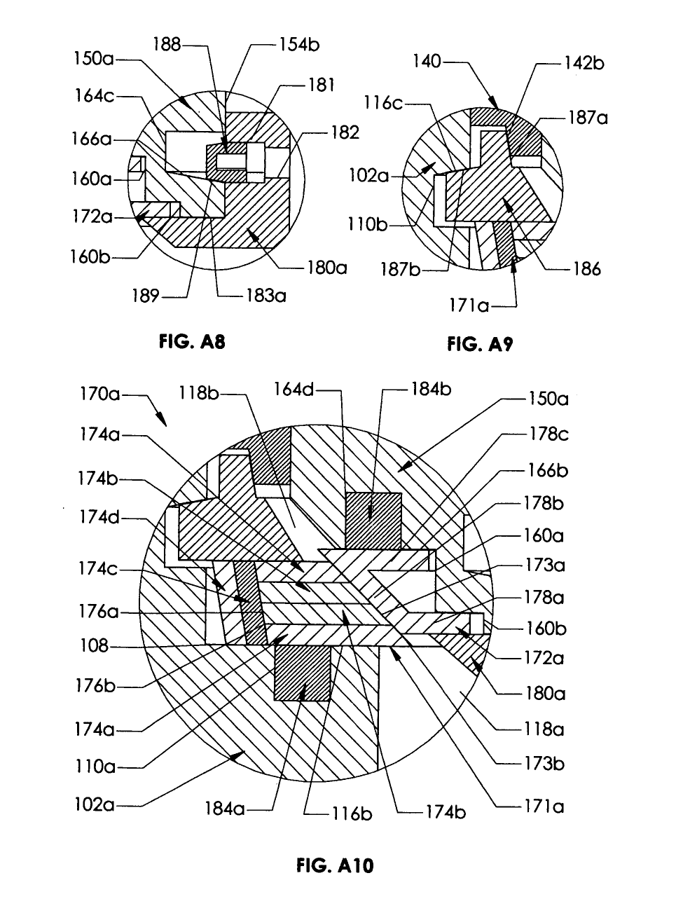

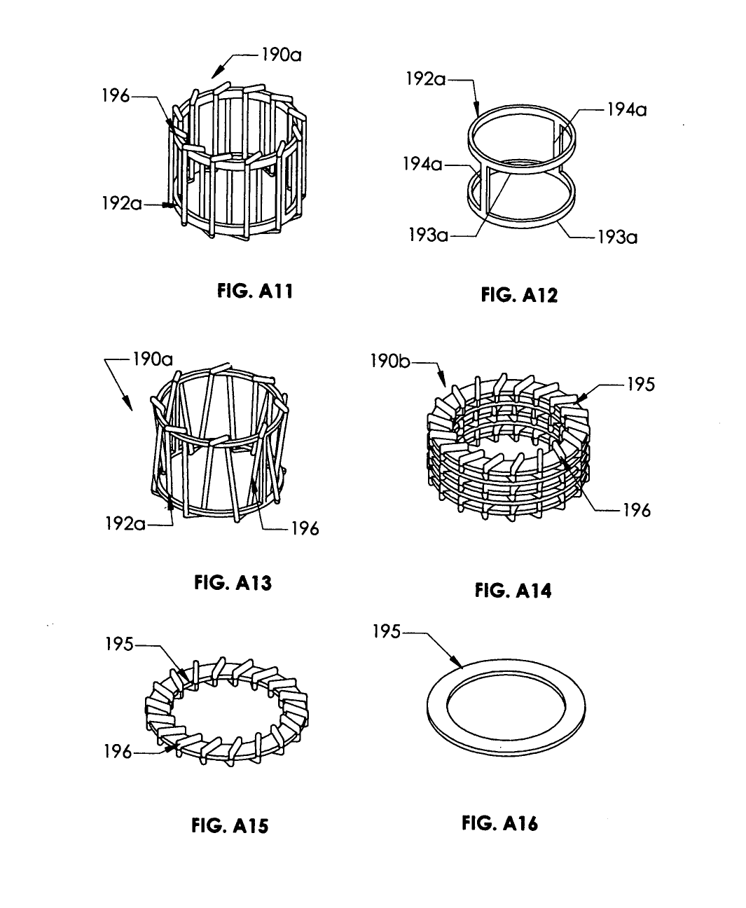

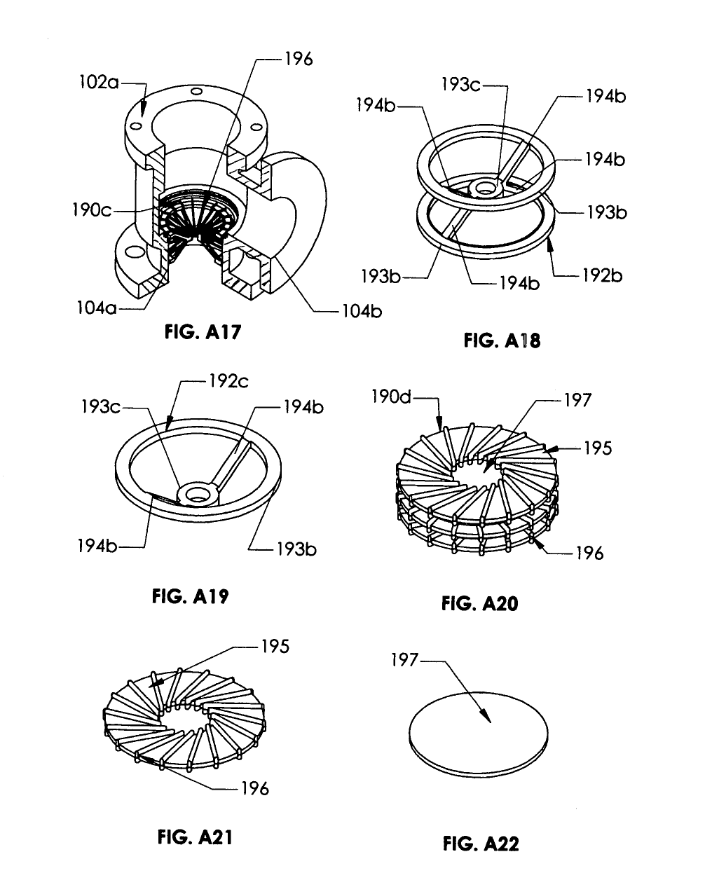

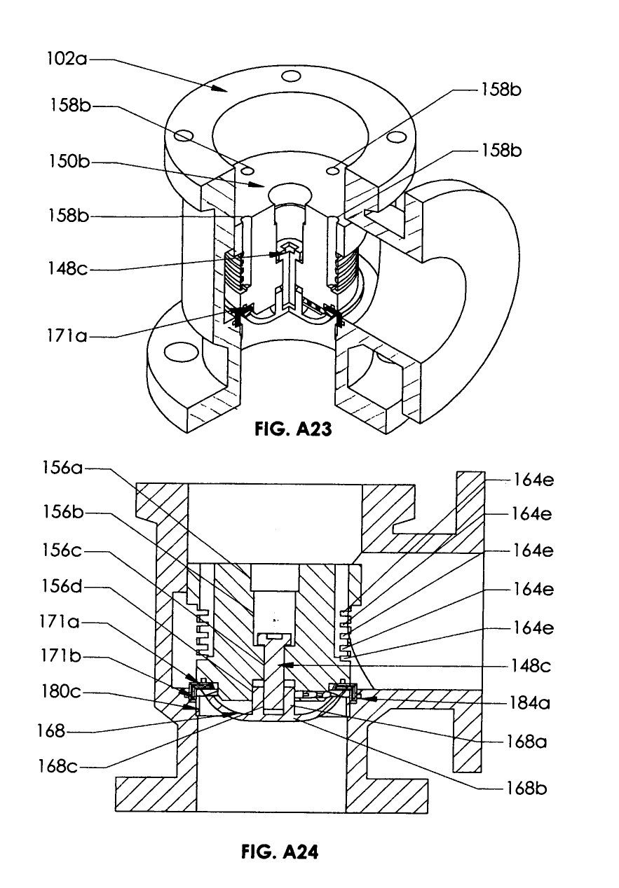

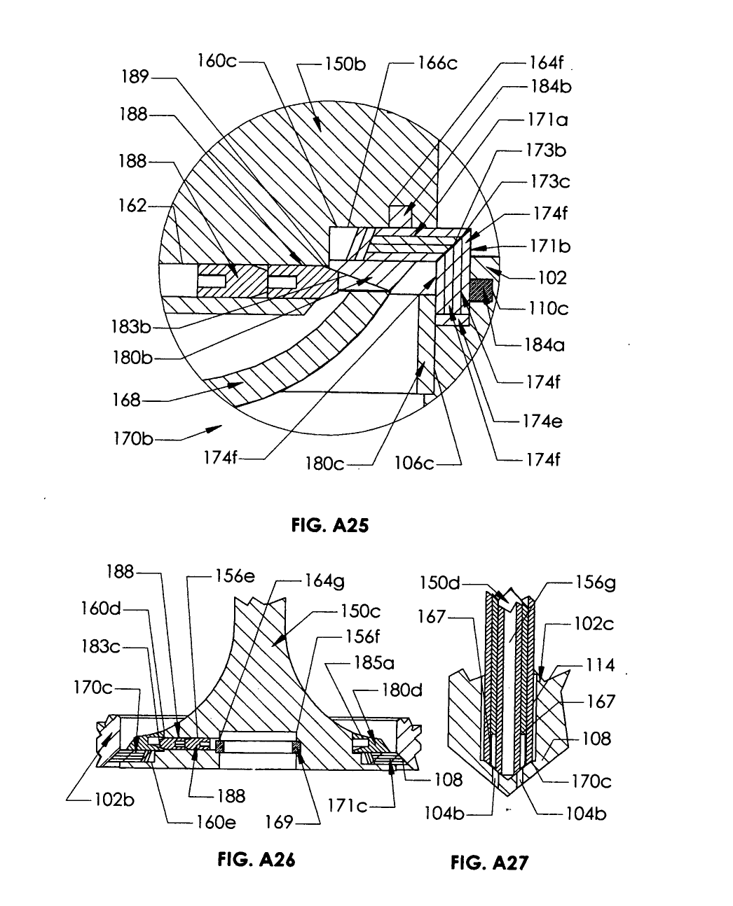

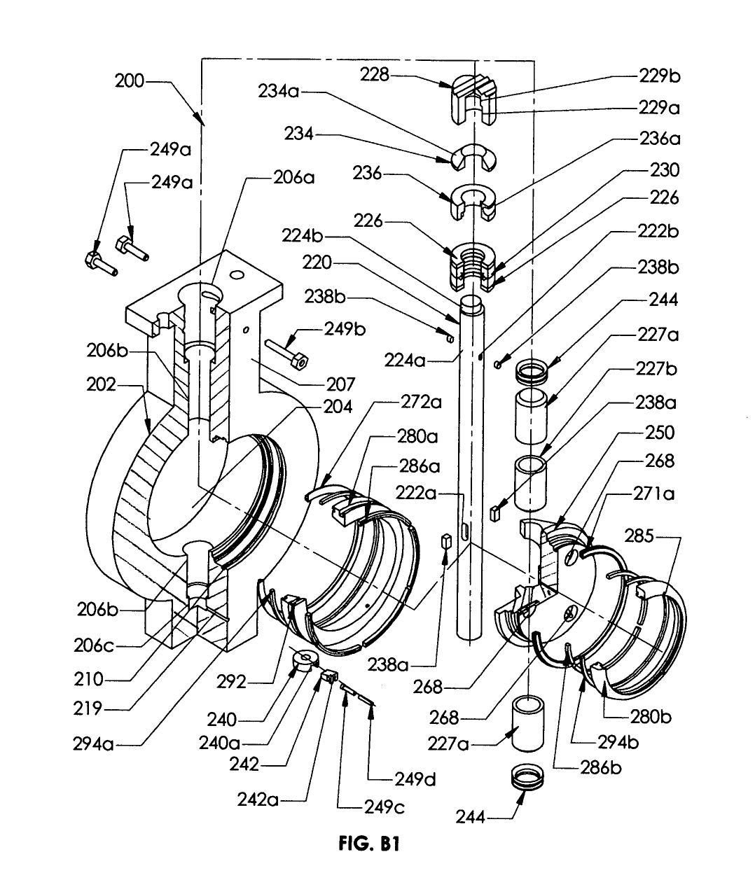

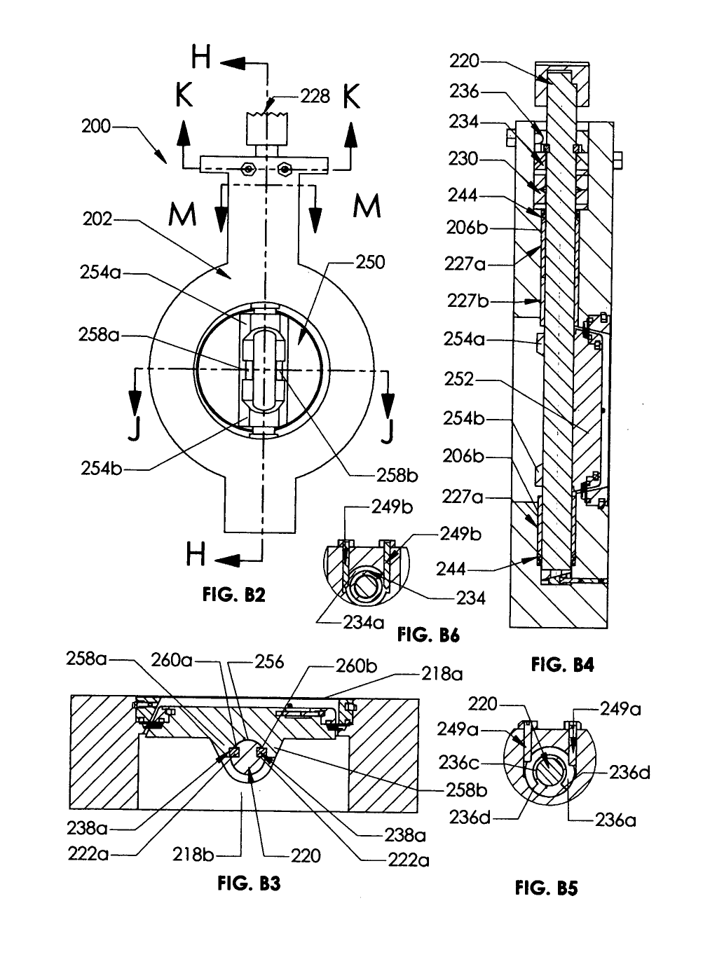

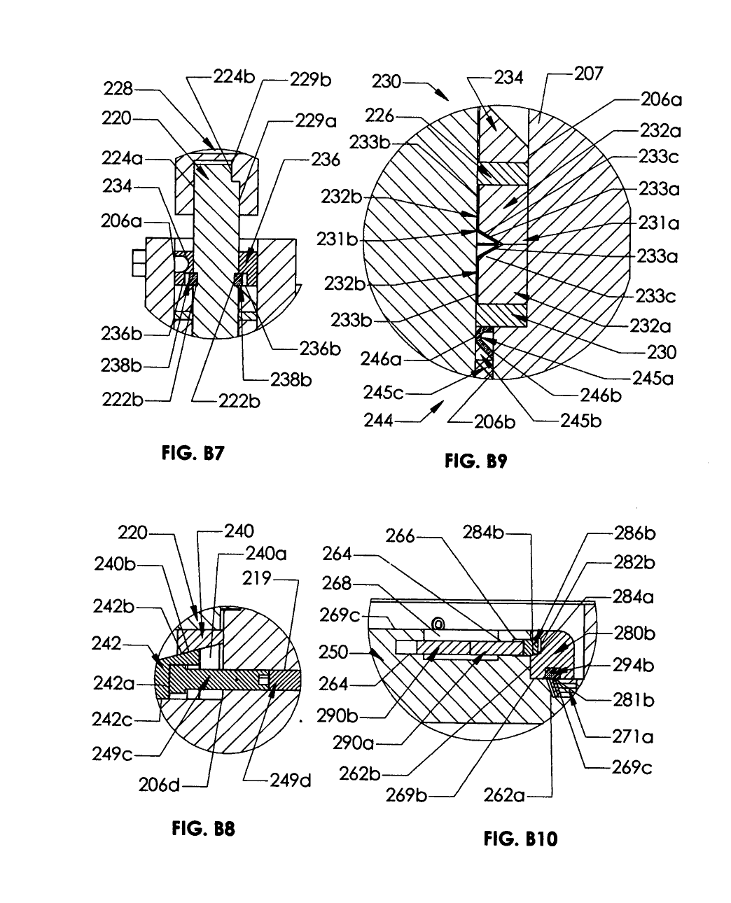

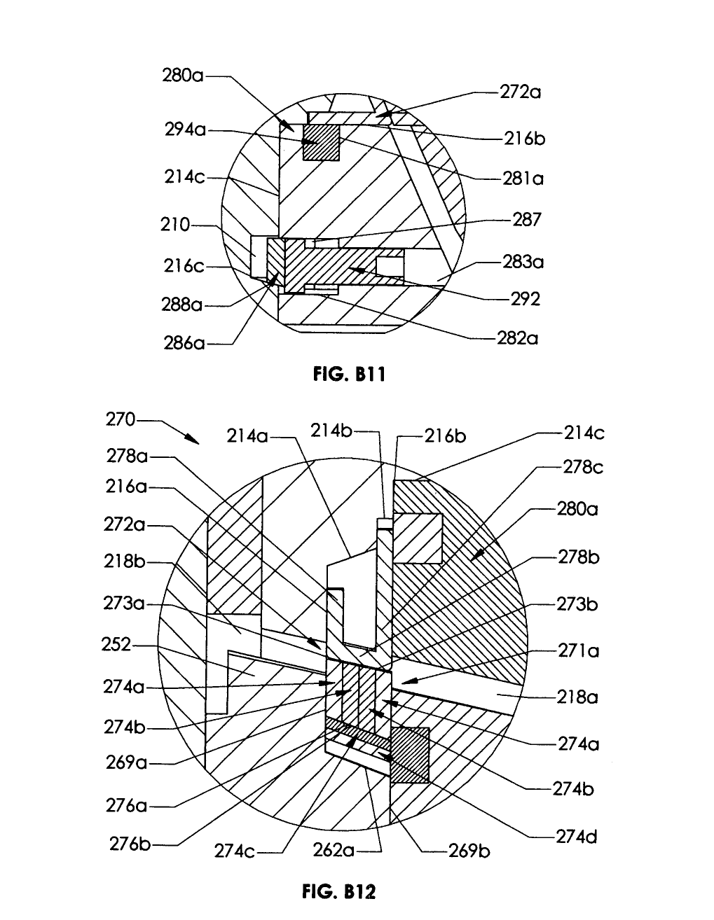

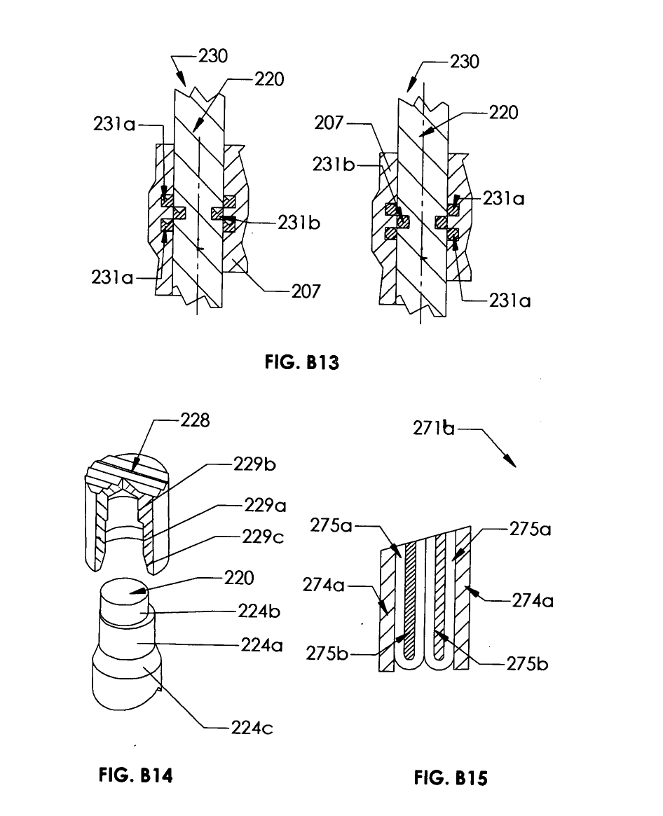

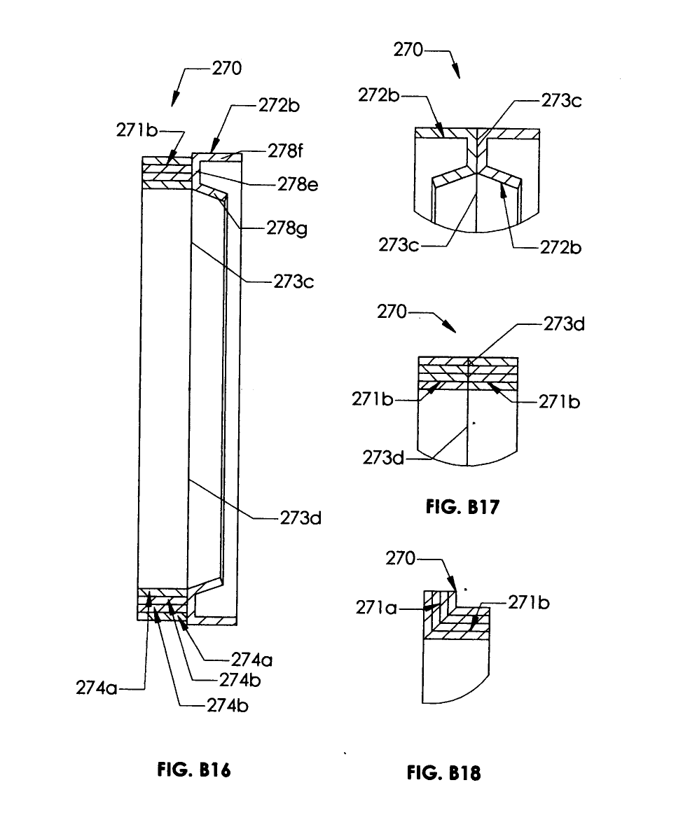

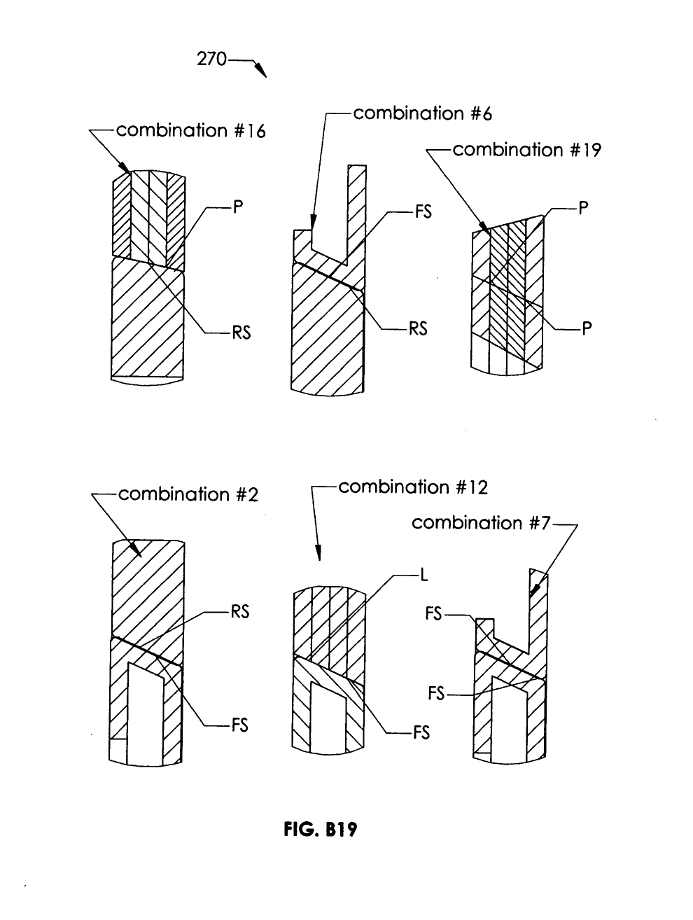

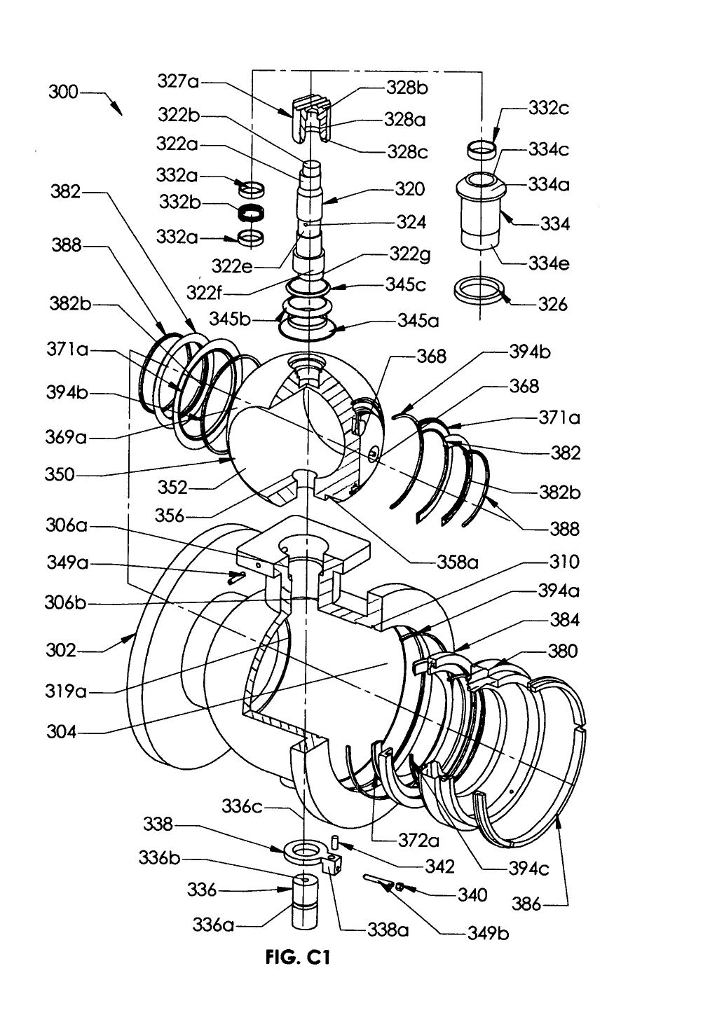

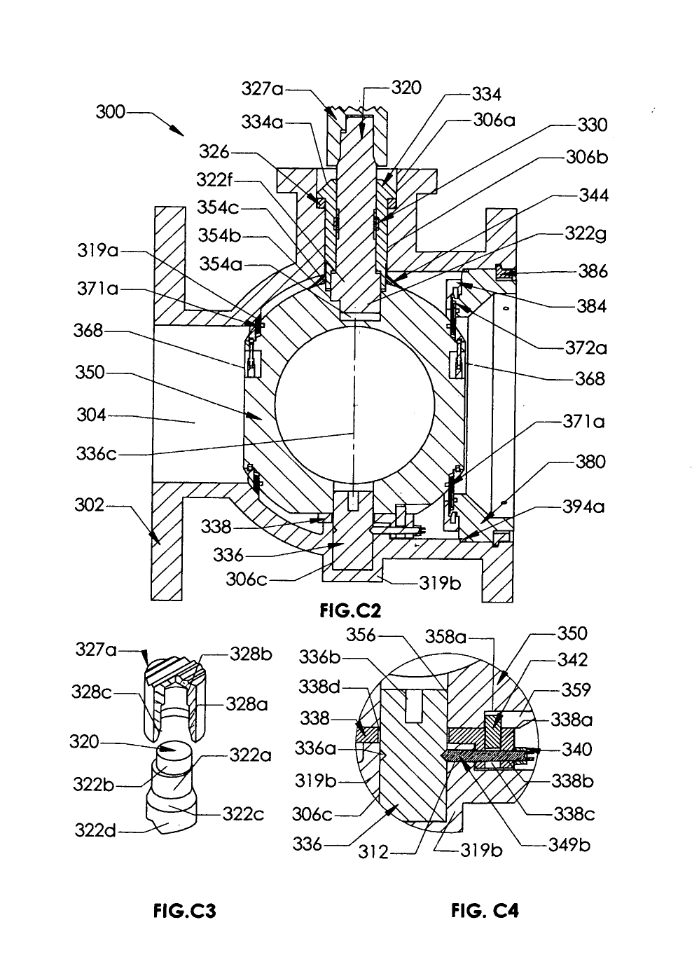

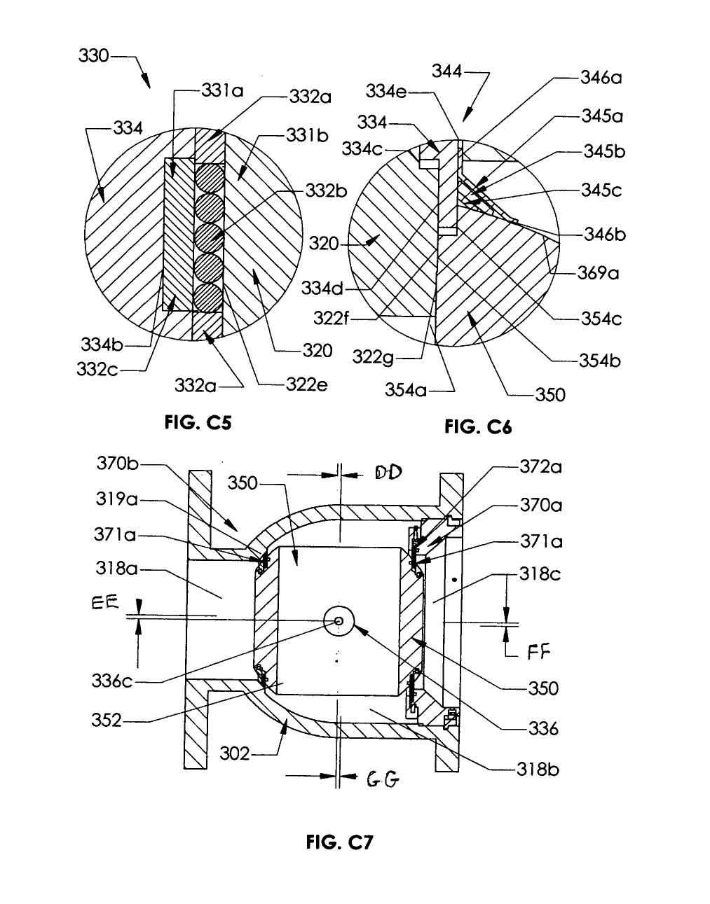

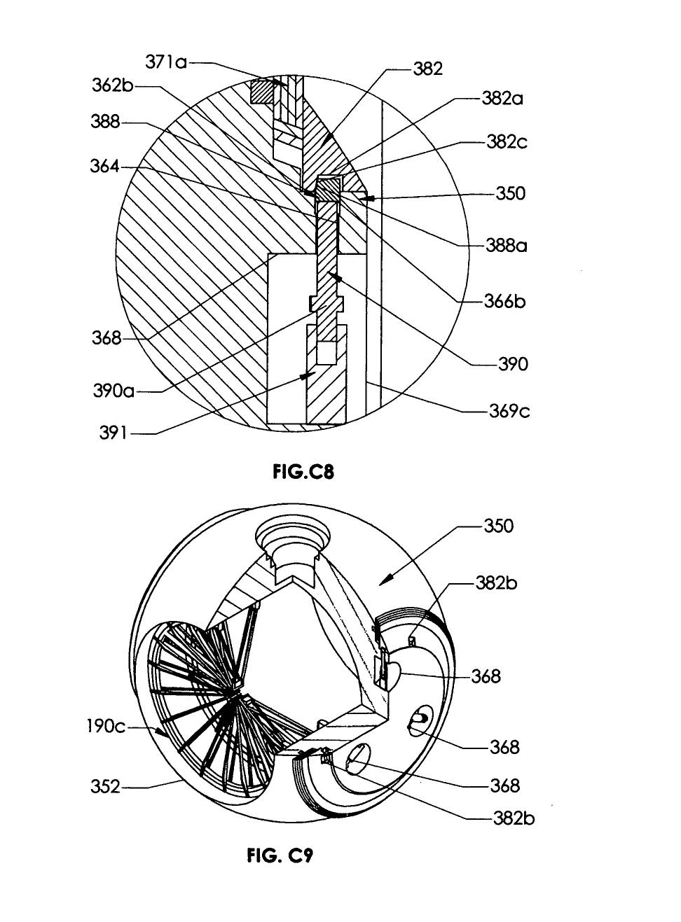

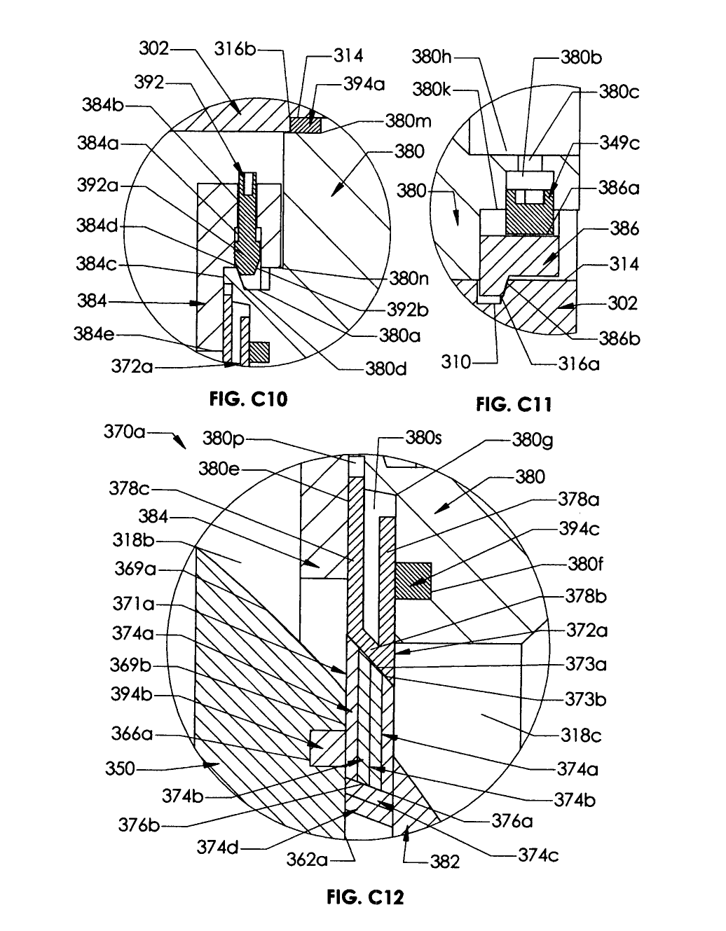

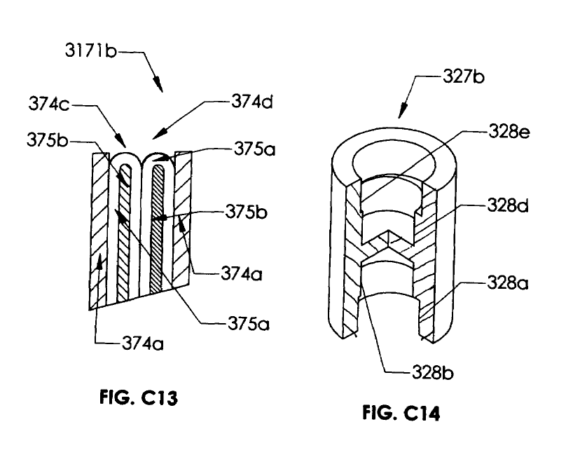

Referring to FIGS. A17-A19, an energy transmission device 190c is disposed in cylindrical ports such as port 104a or port 104b instead of annular recess 114 for storing and releasing flow fluid energy. Device 190c comprises a frame assembly 192b and at least one wire 196 is winded on the frame 192b with gaps between 0.03-1.00 inch (0.76-25.4 mm) as shown in FIGS. 12, 13 or other manners, the frame assembly 192b comprises three ring sections 193b, 193c and rib sections 194b connected with the ring sections 193b, 193c, the rings sections 193b is larger than ring section 193c in terms of diameter. For large flow fluid rate a plurality of ring assembly 190c may be used in a coaxial manner. A frame 192c may be used with limited space and is provided with ring sections 193b, 193c and two rib sections 194b connected sections 193b and 193c.

Referring to FIGS. A20-A22, an energy transmission device 190d may be disposed in a cylindrical section of valve 100. When valve 100 is used for regulating flow fluid pressure. The device 190d comprises a stacked frame assembly having separating plates 197 and rings 195 having spiral winding wires 196 with gaps between 0.03-1.00 inch (0.76-25.4 mm). Plates 197 with a thickness between 0.02-0.38 inch (0.5-10 mm) are sandwiched between rings 195 for prolonging flow fluid paths. The device 190d is provided with predetermined gaps among section of wires 196, plates 197 and rings 195, the gaps create max fluid contact surfaces and length of flow paths for dissipating the fluid energy through energy exchange between ring assembly 190d and the flow fluid. Since the device 190d is an energy consumption device, consumed energy in device 190d is changed to other forms of energy such as; heat energy, mechanical energy or electric energy, the device 190d should be made out of good heat conduct materials for quick heat energy release. For larger device 190d a series of bolts or other types of mechanical fasteners may be used to securely maintain the stacked ring assembly 190d. For applications where ring assembly 190d is used as a standalone product such as diffuser, silencers, or for high flow rate, stacked ring assembly 190d should be point-welded together.

Referring to FIGS. A23 and A24, an alternative plug 150b is disposed in body 102a for smaller sizes of control valve 100. Plug 150b comprises four release holes 158b expending to a plurality of grooves 164e for fluid communication between chamber 118c and chamber 118b. Plug 150b also has a thread hole 156a and a hole 156d connecting a cover 168. Cover 168 comprises a boss 168a, a thread hole 168c and a cap 168b. Cap 168b can be constructed with different profiles for various flow characteristics such as linear, quick opening or equal percentage and others. A screw 148c is threaded into thread hole 168c through holes 156b, 156c for securing cover 168.

Referring to FIG. A25, a seat seal assembly 170b is provided for forming a point/line seal between body 102a and plug 150b. Seat seal assembly 170b comprises a valve member seal assembly or point seal ring unit 171a and a body seal assembly or line seal ring unit 171b. Plug 150b has a recess 160c defined by a surface 166c receiving point seal unit 171a and a groove 164f receiving a gasket 184b for sealing between point seal unit 171a and surface 166c. A retaining ring 180b is disposed in recess 160c against seal ring unit 171a and has a conical surface 183b which has a friction induction texture. Plug 150b has three equally spanned, circumferential thread holes 162 extending to hole 156d shown in FIG. A24. Each of three control screws 188 threaded into each of thread holes 162 is provided with a conical surface 189 engaged with conical surface 183b for securing retaining ring 180b. Each of three lock screws 188 threaded into thread hole 162 is provided for securing control screw 188. An angle of conical surface 183b is substantially the same as an angle of surface 189 and smaller than a self-lock angle. Body 102a has a bore 106c receiving point seal unit 171b and a groove 110c receiving a gasket 184a. A retaining ring 180c is disposed in bore 106c with an interference fit, so cool thermal shrinking or force pressing process is need to install retaining ring 180c. Disassembly of retaining ring 180c can be implemented by pressing up bottom of retaining ring 180c. Retaining ring 180c can be used for other valves such as gate valve, plug valve or check valve.

The line seal ring unit 171b comprises a plurality of coaxial, cylindrical rings 174f. Ring 174f is made out of heat resisted and cryogenic-stable, flexible materials. Seal ring unit 171b also comprises a graphite back rings 174e for preventing fluid seeping among rings 174f. Profile of seal surface 173c of line seal ring unit 171b may be spherical or conical or other shapes and is substantially the same as a profile of seal surface 173b of point seal ring unit 171a.

Referring to FIG. A26, valve 100 comprises an alternative valve member 150c disposed in an alternative body 102b or a part of an engine as an intake or exhaust valve for receiving or releasing fluid in and out of the engine. The valve member 150c comprises a recess 160d receiving a seal ring unit 171c and a recess 160e receiving a retaining ring 180d for securing the seal ring unit 171c, retaining ring 180d comprises a groove 185a defined by a conical surface 183c with a friction induction textures for preventing disengagement with three screws 188, valve member 150c also comprises three circumferential thread holes 156e extending to both a hole 156f and recess 160d, each of the control screws 188 is disposed in each of thread holes 156e and has the conical surface 189 engaged with surface 183c for pressing retaining ring 180d and for securing seal ring unit 171c, each of the lock screws 188 is urged against each of control screws 188 for securing control screw 188, a snap ring 169 is disposed in a groove 164g for preventing screws 188 from falling out of hole 156f.

A seat seal assembly 170c is provided for sealing between valve member 150c and body 102b when valve member 150c is in a closed position. Seat seal assembly 170c comprises a seat 108 on body 102b and seal ring unit 171c, seal ring unit 171c comprises a laminated metal rings and two back rings. Profiles of sealing surfaces between seat 108 and seal ring unit 171c are substantially the same and can be spherical, conical or other shapes.

Referring to FIG. A27, valve 100 comprises an alternative valve member 150d disposed in an alternative body 102c as a needle valve, metering valve or fuel injector for regulating flow fluid in a fluid control system or engine fuel control system. The valve 100 comprises a body 102c and a valve member 150d disposed in the body 102c, the body 102c comprises a recess 114 extending to a conical bottom seat 108 of body 102c and a plurality of outlet ports 104b on body 102c. A seat seal assembly is integrated with valve member 150d and body 102c and is provided with a seal when valve member 150d is in a closed position. Profiles of sealing surfaces between seat 108 and valve member 150d are substantially the same and can be spherical, conical or other shapes. Fluid comes into an inlet port 104a (not shown) through recess 114 and gaps between valve member 150d and a seat 108 into outlet ports 104b which are equally spanned and from a center of body 102c for preventing erosion and cavitations. The valve member 150d comprises a plurality of coaxial thin pipes or tubes which have release slots 167 and a center hole 156g and for absorbing fluid impact force and for preventing erosion and cavitations, if there is no space for recess 114 or high cycle applications, a center hole 156g or release slots 167 can be used as a fluid passage between ports 104a and 104b with modification of ports 104 away from center hole 156g or release slots 167 for preventing erosion and cavitations as a fluid balance mechanism.

Valve body 102a may be constructed with different styles such as globe style, or threaded style, split-body or more than two ports. For three ports style, holes 143 on sleeve 140 should be located circumferentially away from two outlet ports for evenly diving a flow fluid stream from one inlet port into two stream fluids. Body 102a can be made of various metals such as stainless steel. Seat 108 can be constructed as a solid seat, special hard or anti-corrosive materials should be deposited on surface of seat 108 or entice wet surface of body 102a. The deposit process should be implemented by thermal spray such as High Velocity Oxygen Fuel spraying (HVOF) with layer thickness between 0.005-0.020 inch (0.12-0.5 mm).

The best assembly process is accomplished as followings (1) gasket 184b is inserted in groove 164d, then seal ring 172a is disposed in recesses 160a and 160b, retaining ring 180a with screws 188 is inserted in recess 154b, screws 188 are tightened up against groove 164c, then stem 120 is inserted into bore 154a, two lock blocks 126 with screws 148b are inserted into groove 164a from slots 152 and rotated until screws 148b can be operated from bore 154c (2) gasket 184a is inserted in groove 110a, seal ring unit 171a is disposed on seat 108, then lock ring 186 is inserted into groove 110b, sleeve 140 with device 190a and other parts is inserted into body 102a (3) assembled plug 150a with sleeve 140 and other parts is inserted into bore 106b, bonnet 135 with other parts is mounted on top body 102a (4) gland 134 with stem seal 130 is inserted into bore 136a, screws 148a are threaded through body 102a and urged against surface 134a for securing gland 134 and pressing packing 131a.

For assembly of body 102a with plug 150b, the procedure is (1) gasket 184b is inserted into groove 164f, then seal ring unit 171a is disposed in recess 160c, retaining ring 180b is inserted into recess 160c, screws 188 are inserted in thread holes 162 and tightened up against retaining ring 180b, screws 148c is connected with cover 168 by threading into thread hole 168c, then modified stem 120 with thread (not shown) is threaded into thread hole 156a (2) gasket 184a is inserted into groove 110c, then seal ring unit 171b is inserted in bore 106c, cool shrink retaining ring 180c is inserted in bore 106c.

In the best mode of operation, valve 100 are installed in a fluid line, stem 120 is coupled with an actuator for moving stem 120 between open and closed positions, when plug 150a is moving away from seat 108, a fluid stream flows through a gap between seal ring unit 171a and ring 172a from port 104a, then the fluid stream entering into recess 114 through holes 143 and energy transmission device 190a becomes two fluid streams, the two fluid streams joint as one fluid steam in port 104b. For energy transmission device 190c, a flow fluid enters port 104b and flow through plug 150a and device 190c. For plug 150b, when plug 150b is moving up, a fluid stream flows through the gap between seal ring unit 171a and ring 171b from port 104a, if there is any fluid in chamber 118c, the fluid in chamber 118c is flowing out through holes 158b and grooves 164e, then encounters an incoming fluid stream from port 104a, such counter-balanced fluid mechanism depresses cavitations and reduces noise and vibration.

The present invention first adapts novel approaches to regulate flow fluid rates and flow fluid pressures in different manners. The energy transmission devices 190a, 190c are used for regulating flow fluid rate as energy storing devices like capacitors in an electric circuit, while the energy transmission devices 190b, 190d are employed for regulating flow fluid pressure as energy consumption devices. The novel structures are based on the modified fluid control theory (1) flow fluid comprises fluid molecules with voids either in liquid or gas (2) flow fluid comprises two major energy forms; potential and kinetic, potential energy is mainly presented by fluid pressure and kinetic energy is mainly presented by fluid velocity, the fluid energy exchange between the two forms is a function of the distances between fluid molecules, so when distances between fluid molecules increase, the potential energy decreases and the kinetic energy increases and vice versa (3) flow fluid energy exchange between the two forms takes time.

For a century the fluid control industries have made tremendous effort to solve fluid control problems, but no prior arts in the field ever recognize limitations of the conventional fluid control theory, no energy-storing device like energy transmission devices 190a, 190c has been ever developed. For applications of flow fluid rate, the pressure loss is undesirable. With energy transmission devices 190a, 190c, valve 100 not only saves fluid energy, but also minimizes effects of energy loss such as cavitations, vibration, noise and part damages. The principle of energy transmission devices 190a, 190c can be applied for many applications from water dam flow controls to engine fuel controls and soft drink packings, energy transmission devices 190a, 190c can be also used with other flow related devices such as compressors, pumps and valves, the frame and wire can be made out of various materials from cement to plastics. With piezoelectric materials or other flexible material and multiple wires, energy transmission devices 190a, 190c can be used as a flow meter for many applications without restriction unlike the vortex flow meter which is susceptible to external vibrations, energy transmission devices 190a, 190c with multiple wires or wire sections can easily cancel out any external vibration disturbance or noise.

With simple energy transmission devices 190c, 190d for regulating flow fluid pressure, most of fluid energy loss are absorbed by rings and wires as heat energy or non-kinetic energy forms, with various size of wires and rings, or multiple wires, the nature frequencies for each of wires or rings are different to prevent damage of resonance of vibration, the entire flexible wire sections as dumping devices absorb the lost energy instead of rigid surface of solid parts in conventional control devices, the rings and wires which are efficiently made have much longer life. More importantly with wires 196 made out of piezoelectric materials with insulators, valve 100 can be modified for generating electricity or as a flow meter. Energy transmission devices 190c, 190d can be used standalone products as diffuser, silencers and pressure reduction device or installed with other valves such as, butterfly valve, ball valve, plug valve, gate valve and pressure regulators. In short, the energy transmission devices 190a, 190b, 190c and 190d have the best performances and values in terms of the reliability, versatility simplicity and adaptability.

The present invention solves other foundational problem-stem leakage for both reciprocal and rotary stems. With dynamic stem seal assembly 130, inefficient, expensive live load packing in conventional valves is no longer needed, the operation force for stem 120 is dramatically reduced, while the life of stem seal assembly 130 is increased, most importantly, stem seal assembly 130 can have about 10-500 ppm leakage with the novel joint structure between stem 120 and plug 150a which only eliminates the axial freedom and compensate any circumferential offset between the stem and the plug. Stem seal assembly 130 functions still well and compensates any offset between stem 120 and bore 136a after over many cycles based on the industries standards. The secondary stem seal 144 can be constructed with various materials such as PTFE, syntactic rubber or other flexible materials for many other applications.

The present invention also has the novel bubble tight seal structures and the valve members. With novel point/flexible surface seal 170a, valve 100 not only can regulate flow fluid, but also can provide a bubble tight seal shut-off with the simple structure, high reliability and lower cost. Seat seal unit 170b is constructed with the novel valve member 150b, this structure not only provides a bubble tight seal, but also efficiently store and release fluid energy with cover 168 which has various flow patterns with minimum energy loss.

Seat seal unit 170c first time provides the engine valves with the novel seal, the seal not only has bubble tight seal which increase fuel efficiency in the intake side and reduces fugitive emission on the exhaust side, but also has much flexible structure as a spring to store and release combustion energy. The novel seal has much longer life over all the conventional valves in the prior arts with easy and low cost replacements.

The seat seal unit 170d provides other solution to the needle valve or fuel metering valve, the seal again is constructed with a flexible valve member to store and release fluid energy instead of dissipating the energy, the center fluid hole 156g and release slots 167 and the passage in gap the body and valve member create a fluid counter-balanced mechanism for preventing cavitations and erosion either on valve member 150d or outlet ports 104b, with the multiple ports 104b, the body 102c can be various shapes of bottom and with the conical bottom further improves the fluid injection quality in term of evenness and particle sizes of fluid. The accuracy of metering is high and stable, the valve member can be constructed with various materials of the coaxial pipes or tubes, if fluid is coming from recess 114, the layers in the valve member contact fluid are made out of harder material, the rest is made out of flexible material.

The plug seal assembly 146 again provides bubble tight seal with spring ring 147, this seal assembly dramatically reduce the friction between sleeve 140 and plug 150a and can be used for a piston ring in engines, such seal ring not only reduces friction, vibration and ratio between diameter and height of the piston with the round cross section of ring 147, but also improves the piston seal, movement and increase total output efficiency of the engines. In case solid seat is needed, the deposits of the special hard materials is accomplished by thermal spray, such as HVOF, the thermal spray not only has a good quality of surface but also requires less materials and costs.

Other novel constructions of this invention are mechanical joint devices which have three parts; an axial movable ring assembly, circumferential adjustment device and anti-loose device. Most conventional seal ring joint devices employ direct screws or sleeve to secure seal rings, such method not only produce uneven pressing forces on seal rings or multiple, parallel pressing surfaces, but also has a lower reliability with multiple bolting and high probability of screws falling into a pipe lines under vibration or high cycle conditions. With those inclusive retaining devices 180a, 180b, 180c, 186 and 126, no screws 148b, 148c and 188 will fall into a pipeline even under a loose condition, with the self lock angles, friction induction texture surfaces and anti-loose device, no screws 148b, 148c and 188 will not loosen because of vibration or reaction forces, three point forces from screws 148b and 188 are amplified and evenly distributed to lager surface forces, finally cover 168 is provided with an optimal structure efficiently to absorb fluid impact energy and prevent surface damage without expensive hardened materials, cover 168 not only has a locking function, but also can characterize flow pattern with cap 168b, cap 168b can be constructed with various profiles such as quick opening, linear and equal percentage or others, the replace of cover 168 is easy and inexpensive.

### Butterfly Valve

FIGS. B1-B19 illustrate a butterfly valve 200 constructed in accordance with the present invention. The butterfly valve 200 comprises a body 202 having a flow fluid passage 204 therethrough. A valve member or disc 250 is mounted on a stem 220 within the flow fluid passage 204 for movement between open and closed positions. The body 202 is typically adapted for positioning between opposed pipe flanges (not shown). A stem seal assembly 230 is disposed between stem 220 and a packing support or neck 207 of body 202 for preventing fluid leak through a stem bore 206b. A seat seal assembly 270 is provided for sealing between body 202 and disc 250 when disc 250 is on a closed position. A stem adaptor 228 is a part of an actuator (not shown) for transmitting external torques or rotary movements to stem 220.

Referring to FIGS. B1-B4, the disc 250 includes a disk portion 252 and hubs 254a, 254b having a stem hole 256 to receive stem 220. Disc 250 also comprises two integral key holders 258a, 258b having respectively keyways 260a, 260b in a middle of disk portion 252. The stem 220 disposed in the stem hole 256 has two keyways 222a which are matched with keyways 260a, 260b. Two keys 238a are engaged with keyways 260a, 260b of disc 250 and keyways 222a of the stem 220 for transmitting toques or rotary movements between disc 250 and stem 220. Sizes of keys 238a are relatively smaller than clearances between hub 254a and key holders 258a, 258b, so the keys 238a can be installed into keyways 222a from both transverse sides of stem 220 through passage 204 after stem 220 is inserted into stem hole 256.

Referring now to FIGS. B4-B7, the stem 220 is rotatably disposed in stem bore 206b by means of bearings 227a, 227b. The stem 220 has a centric, cylindrical bar section 224a and an eccentric, cylindrical bar section 224b which is parallel to the section 224a, for example 1″ (25.4 mm) diameter stem 220 has 0.06 inches (1.5 mm) offset between centers of sections 224a, 224b. In general the offset is about 1/10- 1/30 of stem diameter 220. The stem adaptor 228 is a part of torque or rotary movement transmission device (not shown) such as handles, actuators, and motors. Stem adaptor 228 comprises a centric, cylindrical bore sections 229a and an eccentric, cylindrical bore section 229b which are respectively engaged with bar section 224a and bar section 224b, an offset between sections 229a, 229b is the same as that between sections 224a, 224b with a transition fit for transmitting rotary movements or torques from an external torque or rotary movement transmission device (not shown) to stem 220.

The stem 220 also is provided with keyways 222b for receiving keys 238b. The keys 238b are provided to prevent any relative rotation between stem 220 and a position ring 236 when stem 220 is rotated. The position ring 236 is disposed in a bore 206a and comprises a stem hole 236c receiving stem 220 and keyways 236b to receive keys 238b along with stem 220. Position ring 236 also has a moon-shaped groove 236a defined by two surfaces 236d. Two screws 249a are threaded through neck 207 into groove 236a for limiting rotation of stem 220 at a predetermined position. The screws 249a can be constructed with limit switches (not shown). Position ring 236 along with keys 238b and screws 249a are provided for preventing an axial, outward ejection of stem 220 under a fluid pressure in case of breakdown of stem 220.

Referring now to FIG. B8, a bottom of stem 220 is supported by a thrust bearing 240. The thrust bearing 240 has a wedged slot 240a defined by a surface 240b defined by a angle for receiving a wedge 242, the wedge 242 includes a surface 242b engaged with surface 240b, an angle of surface 242b is the same as that of surface 240b. Wedge 242 also has a T-slot 242a and a flat button surface 242c engaged with a bottom of a bore 206c. A large-head control screw 249c disposed in T-slot 242a is threaded into a thread hole 219 for axially positioning stem 220 by mean of wedge mechanism, a lock screw 249d is threaded into hole 219 and urged against one end of screw 249c for securing control screw 249c position.

Referring now to FIG. B9, the stem seal assembly 230 is disposed between bore 206a and stem 220 and comprises a bore packing 231a, a stem packing 231b, and a secondary seal assembly 244. The bore packing 231a comprises a pair of upper and lower rings 232a with conical sections 233a, the packing rings 232a are made out of heat resisted and cryogenic-stable, relatively flexible materials such as graphite, reinforced PTFE and soft metal. The stem packing 231b comprises a pair of upper and down delta rings 232b which are disposed within bore packing 231a. The delta ring 232b has a cylindrical section 233b and a conical section 233c which is fully engaged with the conical section 233a, an angle of conical section 233c is substantially the same as that of sections 233a, a thickness of delta rings 232b is between 0.01 and 0.12 inches (0.25-3 mm). The delta rings 232b are made out of heat resisted and cryogenic-stable, relatively flexible materials such as spring stainless steels, reinforced PTFE. Section 233b has an interference fit with stem 220, a thermal process is required for either enlarging a diameter of section 233b or shrinking a diameter of stem 220. Two clamp rings 226 are disposed on top and bottom of stem seal assembly 230, the clamp rings 226 are made out of heat resisted, cryogenic-stable materials such as graphite, reinforced PTFE and soft metals. A gland 234 is disposed on top of clamp ring 226 and comprises a conical surface 234a, each of two screws 249b has a conical tip engaged with conical surface 234a circumferentially for pressing packing 231a at a predetermined position as shown in FIG. B6. When stem 220 has a relative movement against bore 206a, the packing 231a is attached to bore 206a, while packing 231b is attached to stem 220 and there is no relative movement between packing 231a and bore 206a, or packing 231b and stem 220, so both packings 231a, 231b can compensate any offset between stem 220 and bore 206a when stem 220 is moving.

The secondary stem seals 244 are disposed between stem 220 and stem bore 206b. The seal 244 comprises a metal half-S ring 245a and graphite delta rings 245b and 245c, the ring 245a has an inner surface 246a with a transition fit with stem 220 and an outer surface 246b with an transition fit with stem bore 206b, delta rings 245b and 245c are provided for an axial constrain and seal. When stem 220 is moving, ring 245a is float and can be attached either to stem 220 or to stem bore 206b for compensating any offset between center of stem 220 and center of stem bore 206b.

Referring to FIG. B 10, a disc retaining ring 280b is disposed in a recess 262b defined by a surface 269b for securing a point seat ring unit 271a. The retaining ring 280b has a groove 281b receiving a gasket 294b for sealing between seal ring unit 271a and surface 269b. The retaining ring 280b also has a groove 282b having a conical surface 284a defined by an angle for receiving a lock ring 286b, the lock ring 286b has a conical surface 284b which are engaged with surface 284a for transmitting circumferential movements to axial movements. The lock ring 286b is constructed as three segments. An angle of the conical surface 284b is substantially same as that of conical surface 284a and less than a self-lock angle. Retaining ring 280b is provided with three access slots 285 equally spanned for disassembly of seal rings unit 271a shown in FIG. B1. Disc 250 is provided with three cavities 268 on a surface 269c and three circumferential threaded holes 264 through the three cavities 268, three control screws 290a threaded in threaded holes 264 are urge against lock ring 286b in groove 282b and in turn for urging point seal ring unit 271a. Three lock screws 290b are threaded into thread holes 264 urged against the control screws 290a for securing control screws 290a. Sizes of cavities 268 should be large enough for operating the screws 290a, 290b and small enough for preventing screws 290a, 290b from falling out of the cavities 268. If retaining ring 280b has no space for lock ring 286b, the screw 290a with a modified conical tip (not show) is engaged with surface 284a for pressing point seat ring unit 271a.

Referring to FIG. B11, a body retaining ring 280a for securing a flexible surface seal ring 272a is disposed in a recess 214c having a surface 216b and a groove 210 having a conical surface 216c. Retaining ring 280a has a groove 281a receiving a gasket 294a for sealing between seal ring 272a and surface 216b. Retaining ring 280a also comprises a groove 282a receiving a lock rings 286a with a loose fit. The lock ring 286a has a conical surface 288a which are engaged with conical surface 216c for transmitting circumferential movements to axial movements. The lock ring 286a is constructed as three segments with three circumferential T-slots 287. An angle of the conical surface 288a is substantially same as that of conical surface 216c and less than a self-lock angle for preventing any loose engagement between surfaces 288a, 216c. The retaining ring 280a also has three circumferential thread holes 283a extending to groove 282a. Three large-head screws 292 disposed in three T-slots 287 are threaded into holes 283a for positioning lock ring 286a in groove 210 with a loose fit and in turn pressing flexible surface seal ring unit 272a or for removing seal ring 272a. If retaining ring 280a has no space for lock ring 286a, the screw 292 with a modified conical tip (not shown) is engaged with surface 216c for pressing flexible surface seal ring 272a.

Referring to FIG. B12, the seat seal assembly 270 comprises the point seal ring unit 271a as a valve member seal assembly and the flexible surface seal ring 272a as a body seal assembly. The seal ring 272a is disposed in a taped recess 214a defined by a surface 216a and is secured by the retaining ring 280a in a recess 214b, while the seal ring unit 271a is disposed in a taped recess 262a defined by a surface 269a and is secured by the retaining ring 280b. A peripheral seal surface 273a of seal ring 272a are engaged with a peripheral seal surface 273b of seal ring unit 271a for forming a point/flexible surface sealing between chambers 218a and 218b, profiles of surfaces of 273a, 273b are substantially the same and can be spherical, conical or other mating shapes.

The point seal ring unit 271a comprises two outmost metal holding rings 274a and multiple middle point rings 274b. Seal ring unit 271a also comprises two conical back rings 274c, 274d, the metal back ring 274d has a larger outside diameter than an inside diameter of seal rings unit 271a, so the graphite back ring 274c supported by metal back ring 274d generates a compression between a conical surface 276a of seal ring unit 271a and a surface 276b of back ring 274c for preventing fluid seeping among rings 274a, 274b, middle point rings 274b are made out of wire, the seal surface 273b of middle point rings 274b is defined by a plurality of rectangle cross section of metal wires. Area of cross sections is between 0.007-0.011 square inch (0.45-7.1 square mm).

The flexible surface seal ring 272a having a half-H ring comprises a seal surface section 278b, a support section 278c and a floating section 278a. The support section 278c is secured by the recess 214b and retaining ring 280a. Thickness of ring 272a is between 0.01 and 0.18 inch (0.25-4.6 mm). Seal ring 272a can be made out of metal or metal with anti-corrosive, abrasive coatings or base metal with a deposit of special material with thickness between 0.005-0.020 inches (0.13-0.51 mm), the deposing process is implemented by thermal spray process such as High Velocity Oxygen Fuel (H VOF).

Referring to FIG. B13, the stem seal assembly 230 also comprises many other shapes of packing such as O, V or other shapes for bore packing 231a and stem packing 231b which are closed contacted with each other and can be used for both reciprocal stem and rotary stem.

Referring to FIG. B14, the stem 220 and stem adaptor 228 may be provided with additional conical mating sections 224c and 229c for high joint concentricity applications. Solid section 224c is concentric with the solid section 224a, while bore section 229c is concentric with bore section 229a. Profiles of sections 224c and 229c are the same.

The seat seal assembly 270 also has a plurality of geometric seal elements and combinations of the geometric seal elements for different applications. A point-line seal ring unit 271b can be constructed by sandwiching thin sheet rings 275b between wire rings 275a shown in FIG. B 15. Shape of cross section of wire 275a can be rectangle, triangle, round or other shapes, the thin sheet ring 275b can be made of metal, graphite, a thickness of ring 275b is between 0.01-0.18 (0.25-4.5 mm), so total number of basic geometric seal elements is five including (1) the point seal element defined by point seal ring unit 271a (2) the flexible surface seal element defined by flexible seal ring 272a (3) the point-line seal element defined by point-line seal ring unit 271b (4) the line seal element defined by the conventional radial laminated seal ring and axial laminated seal ring with the coaxial multiple pipes or tubes defined by ring 171b shown in FIGS. A25 and A27 (5) a rigid surface seal element which is defined by either a valve member seal assembly as an integral part of disc or a body seal assembly as an integral part of body or any other solid parts. Those five geometric seal elements can be constructed either on body 202 or disc 250.

So far the seat seal assembly 270 is constructed with circumferential (radial) mating seal surfaces, but the seat seal assembly 270 also can be constructed with axial (face) mating seal surfaces which comprises a point/flexible surface seal elements shown in FIG. B16, a flexible surface ring 272b comprises a seal section 278e, a floating section 278g and a support section 278f, while a point seal ring unit 271b comprises two outmost holding rings 274a and multiple middle point rings 274b, two mating surfaces 273c and 273d are provided for forming a point/flexible surface seal, other combinations such as a flexible surface/flexible surface seal and a point/point seal are shown in FIGS. B17. Seat seal assembly 270 also comprises mixed mating seal surfaces having an axial surface and a circumferential surface shown in FIG. B18 and the seat seal assembly 170b shown in FIG. A25. Seat seal assembly 270 can be used as a seal between relative linear or rotary moving parts such as rotary valves and liner valves or two stational parts. A solution map for various seal applications can be compiled with all possible combinations of the five seal geometric elements. Table. 1 shows 25 of combinations of the seal elements of seat seal assembly 270 with conical mating surfaces in a butterfly valve, the combinations of #2, #6, #7, #12, #16 and #19 are shown in FIG. B19.

TABLE 1

| Combination | #1 | #2 | #3 | #4 | #5 |
|---|---|---|---|---|---|
| Body | RS | RS | RS | RS | RS |
| Disc | RS | FS | L | P | P/L |
| Combination | #6 | #7 | #8 | #9 | #10 |
| Body | FS | FS | FS | FS | FS |
| Disc | RS | FS | L | P | P/L |
| Combination | #11 | #12 | #13 | #14 | #15 |
| Body | L | L | L | L | L |
| Disc | RS | FS | L | P | P/L |
| Combination | #16 | #17 | #18 | #19 | #20 |
| Body | P | P | P | P | P |
| Disc | RS | FS | L | P | P/L |
| Combination | #21 | #22 | #23 | #24 | #25 |
| Body | P/L | P/L | P/L | P/L | P/L |
| Disc | RS | FS | L | P | P/L |

RS = Rigid Surface, FS = Flexible Surface, L = Line, P = Point, P/L = Line/Point

The valve 200 also has a plurality of constructions for different applications. Body 202 can be constructed with a flange style, lug style or other connection styles and be made of various materials such as stainless steel, alloy steel. Seal ring 272a may be integral to body 202 or disc 250, special hard or anti-corrosive materials may be deposited on a seal surface of either body 202 or disc 250 or an entice wet surface of valve 200. The deposit process may be implemented by a thermal spray such as High Velocity Oxygen Fuel spraying (HVOF) with a layer of thickness between 0.005-0.020 inch (0.13-0.51 mm).

The assembly of valve 200 is accomplished as followings (1) with heating expansion of inside diameter of rings 232b, or cooling shrink of diameter of stem 220, rings 232b is disposed axially into stem 220 at a predetermined position (2) screws 290a, 290b are threaded into holes 264, then point seal ring unit 271a is disposed in disc 250, retaining ring 280b with gasket 294b and lock ring 286b is disposed into disc 250 for securing point seal ring unit 271a, screws 290a are tightened up against lock ring 286b until retaining ring 280b firmly against point seal ring unit 271a (3) screw 249c is threaded through bore 206c into thread hole 219, wedge 242 with thrust bearing 240 is inserted into bore 206c with other parts (4) the assembled disc 250 is inserted into passage 204, then assembled stem 220 with other parts is inserted into body 202 through stem hole 256 of hub 254a, then two keys 238a are inserted into keyways 222a from both transverse sides of stem 220, then stem 220 is pressed further down until keys 238a are fully engaged with keyways 260a, 260b (5) finally with complete assembly of other parts, screws 249a, 249b and 249d are threaded into body 202 until reaching at a proper positions.

In the best mode of operation, valve 200 are installed in a pipeline system, stem adaptor 228 is coupled with stem 220 for rotating stem 220 between open and closed positions. First, screw 249b should be properly adjusted with no leakage and relatively low operation torques, second stem 220 should have properly adjusted with travel limit, when valve 200 is fully closed, one of screws 249a should stop rotation of position ring 236 and when valve 200 is fully open, one of screws 249a should stop rotation of position ring 236, third surface seal ring 272a is properly matched with point seal ring unit 271a, if there is vertical offset, screw 249c should be properly adjusted, then screw 249d is threaded in and locked against screw 249c, otherwise screws 290a, 290b or screws 292 should be properly readjusted.

The present invention first adapts a novel method to map all possible solutions instead of seeking one solution at a time in the conversional way. Metal-to-metal seal first time has a “DNA” map with five geometric “DNAs” and all possible combinations or makeup. With combinations of the five geometric seal elements in this invention, metal-to-metal seals not only have a good sealability like the resilient seal, but also have a much wider range of applications and advantages
(1) Reliability. The point/point seal or point-line seal has the highest reliability over all seal structures in the prior arts. A point is a basic geometric element, if a point is damaged, the surrounding points are still functional. The point seal or point-line seal element is well suitable for absorbing any impact force of high velocity fluid, quick moving part or high thermal change and applications such as liquidized gas delivery or control systems, engine intake or exhaust valve, engine/rocket fuel injection control systems or other fluid control system under extreme conditions. The point seal element with round cross section of wire has a superior ability to absorb a heat shock that no other solid alloy material can match, with the nature of triangle stability, the point seal element with triangle cross section of wire has archived a fine balance between sealability and flexibility for many challenging applications.
(2) Versatility. The seal element combinations in any seal surface profile or any type of relative movement between the valve member and the body can have up to maxim 25. For high abrasive or high impact force applications, a line/line seal is well suitable, for positive bidirectional seal or low torque; one flexible surface seal should be included. The point-line seal vs. flexible surface seal is provide with a good seal with relative low cost. A spherical mating profile for constant seating and unseating forces on linear valves is much superior over conventional wedged profile, finally for extreme high temperatures or limited spaces, one rigid surface with additional layer of hard or other special purpose materials can be selected, the HVOF may be used for adding additional material layer.
(3) Simplicity. The seal geometric elements are very simple in terms of structure and do not depend on fluid pressure for a seal.
(4) Adaptability. Five seal elements can be applied for any types of mating surfaces, conical, spherical, wedged and other shapes. The location of seal elements can be either on a valve body or valve member, the peripheral mating surfaces can be circumferential surfaces or axial surfaces or mixed. The seal elements can be used for any type of relative movement between stationary part and moving part, and stationary parts.

The present invention solves other foundational problem-stem leakage. With the dynamic stem seal assembly 230, inefficient, expensive live load packings in the conventional valves are no longer needed, the operation torque for stem 220 is dramatically reduced, while the life of stem seal assembly 230 is increased, most importantly, stem seal assembly 230 has a leakage between 10-500 ppm, even after over many cycles based on many industries standards, the stem seal assembly 230 still well function.

The present invention also provides the most profound solution for a stem joint between stem 220 and stem adaptor 228. The simple, reliably stem joint means truly provides a backlash-free, keyless rotary stem join for many applications, such a stem joint not only provides the best joint quality over all other joints in the prior arts, such as key, pin, square or double-D joint, but also eliminates expensive keyway broaching, destructive hole drilling, stem square milling, strength of the stem joint has at least 15% higher than conventional stem joint with less stress concentricity with a same diameter of stem.

Other novel constructions of this invention are mechanical joint devices that include three parts; an axial movable ring assembly, a circumferential adjustment device and anti-an loose section. Most conventional seal ring joint devices are provided with many screws or bolts directly to secure seal rings o in an axial direction, such a method not only produces uneven pressing forces on seal rings among the screws or blots and unbalanced forces on retaining rings, but also has lower reliability with multiple bolting and a high risk of screws falling into a pipeline system under vibration or high cycle conditions. With those inclusive retaining rings 280a, 280b, no screws 290a, 290b, 292 or lock rings 286a and 286b will fall into a pipeline system even under loose condition. With the self-lock angle and wedge mechanism, rings 286a, 286b, screws 290a or 292 will not loosen because of reaction forces. On the contrary, point forces from screws 290a or 292 are amplified and evenly distributed through lock rings 286a, 286b to lager surface forces on retaining rings 280a, 280b, more importantly those retaining devices can be used for any other valves such as plug valves, ball valve, control valve and gate valves.

Finally assemblies of stem 220 and disc 250 are constructed with other novel devices in this invention. With the simple position ring 236, only top of stem 220 is under torsion stress in case of over travel of stem 220, while the seat seal assembly 270 will not be subject to over-press by the over travel, moreover the position ring 236 with key 238b effectively prevents stem 220 blow off out of bore 206a under fluid pressure in case stem 220 is broken down. With the middle balance keyways 260a, 260b, the key joint between stem 220 and disc 250 evenly distributes the loading and eliminates the expensive broaching process for conventional keyway, moreover the keys 238a are disposed in inclusive keyways 260a, 260b without any lock and will not fall in a pipeline system even under a loose condition.

### Ball Valve

FIGS. C1-C14 illustrate a ball valve 300 constructed in accordance with the present invention. The ball valve 300 comprises a body 302 having a flow fluid passage 304 therethrough. A valve member or ball 350 is disposed in the flow fluid passage 304 by means of an upper stem 320 and a thrust stem 336 for movement between open and closed positions. The body 302 is typically adapted for positioning between opposed pipe flanges (not shown). A stem seal assembly 330 is provided with a seal between a packing support or gland 334 and stem 320. Seat seal assemblies 370a, 370b are provided with seals between body 302 and ball 350 when ball 350 is in closed position. A stem adaptor 327a is typically a part of torque or rotary movement transmission device (not shown) for transmitting external torques or rotary movements to stem 320.

Referring to FIGS. C1-C3, the stem 320 is rotatably disposed in a bore 306b by means of gland 334 for transmitting torques or rotary movements between stem adapter 327a and ball 350. Stem 320 has a centric, cylindrical bar section 322f and an eccentric, cylindrical bar section 322g which is parallel to the section 322f, the bar sections 322f, 322g are respectively engaged with a centric bore 354b and an eccentric bore 354a of ball 350 for transmitting movements between stem 320 and ball 350 with transition fits, for example, 1″ (25.4 mm) diameter stem 320 has 0.06 inch (1 mm) offset between two centers of sections 322g and 322f, in general, the offset is about 1/10- 1/30 of the diameter of stem 320, the offset between sections 322f and 322g is substantially the same as that between sections 354b and 354a. Stem 320 also has a centric, cylindrical bar section 322a with a conical bar section 322c and an eccentric, cylindrical bar section 322b which is parallel to section 322a for coupling with stem adaptor 327a. Stem adaptor 327a comprises a centric, cylindrical bore 328a with a conical bore section 328c and an eccentric, cylindrical bore 328b, an offset between bores 328a, 328b is substantially the same as that between sections 322a, 322b, a profile of conical section 328c is the same as a profile of conical section 322c, bore sections 328a, 328b are respectively engaged with bar sections 322a, 322b for transmitting torques and movements between stem 320 and stem adaptor 327a with clearance fits. The gland 334 receiving stem 320 is disposed on top of a graphite ring 326 in a bore 306a, two screws 349a are circumferentially threaded into bore 206a and provided with conical tips engaging with a conical surface 334a of gland 334 for securing gland 334 and pressing ring 326.

Referring to FIG. C4, the thrust stem 336 is disposed in a bore 306c of a boss section 319b and a bore 356 of ball 350 with a clearance fit for constraining ball 350 and a thrust bearing 338. Thrust bearing 338 includes a hole 338d receiving thrust stem 336 and is sandwiched between ball 350 and boss section 319b, thrust bearing 338 also includes a boss 338a having a vertical hole 338c receiving a pin 342 with a loose fit and a horizontal threaded hole 338b receiving a screw 349b. One end of pin 342 is disposed in a moon-shape groove 358a with an access slot 359 for limiting ball 350 rotation at a predetermined position, while screw 349b is threaded through hole 338b and a hole 312 and engaged with a groove 336a for securing thrust stem 336 and thrust bearing 338, a nut 340 is provided to secure screw 349b. Thrust stem 336 also has a thread hole 336b for disassembly.

Referring now to FIG. C5, the stem seal assembly 330 is disposed between gland 334 and stem 320. Stem seal assembly 330 comprises a bore packing 331a, a stem packing 331b, and a secondary stem seal 344. The bore packing 331a is disposed in a groove 334b and comprises a ring 332c having rectangle cross section, ring 332c is made out of heat resisted and cryogenic-stable, relatively flexible materials such as graphite, reinforced PTFE and soft metal, the stem packing 331b is disposed in a groove 322e and comprises a pair of rings 332a and a compressed spiral spring ring 332b between rings 332a. Ring 332a is made out of heat resisted and cryogenic-stable, relatively flexible materials such as graphite, reinforced PTFE and soft metal, spring ring 332b is provided with one end inserted into a hole 324 shown in FIG. C1 for preventing relative movements between stem 320 and ring 332b, spring ring 332b is made out of heat resisted and cryogenic-stable, relatively flexible materials such as spring stainless steel, or spring stainless steel with reinforced PTFE coating or cover, when stem 320 has a relative movement against gland 334, the packing 331a is attached to gland 334, while packing 331b is attached to stem 320 and there is no relative movement between packing 331a and gland 334, or packing 331b and stem 320, so both packings 331a, 331b can compensate any offset between stem 320 and gland 334 when stem 320 is moving.

Referring now to FIG. C6, the gland 334 also comprises bores 334c, 334d receiving stem 320 with a clearance fit and a recess 334e extending into a bore 354c, the secondary stem seal 344 disposed in recess 334e comprises delta metal rings 345a, 345b and 345c. The delta metal rings 345a, 345b, 345c have an upper surface 346a with a transitional fit with gland 334 and a lower surface 346b engaged with a surface 369a for seal between ball 350 and gland 334, when stem 320 is moving, stem seal 344 with gland 334 is stationary and provided with a dynamic seal between ball 350 and gland 334.

Referring to FIG. C7, the ball 350 is rotatably disposed in body 302 at a closed position and is provided with seat seal assemblies 370a, 370b with a spherical profile for seals among chambers 318a, 318b and 318c. Ball 350 has a port 352 and is constructed substantially in a centric symmetry from an axis 336c which is concentric with centers of stems 320, and 336. The seat seal assembly 370a comprise a point seal ring unit 371a and a flexible surface ring 372a and has two offsets; EE in a vertical direction and DD in a horizontal direction from axis 336c, for example, both EE and DD are 0.03 (0.25 mm), in an opposite direction, a seat seal assembly 370b comprises point seal ring unit 371a and a seat section 319a and has two offsets; FF in the vertical direction and GG in the horizontal from axis 336c, EE and DD are respectively, substantially the same as FF and GG. When ball 350 is rotated clockwise to full open position, both seal ring units 371a will quick disengaged with seat section 319a and seal ring 372a for reducing rubbing and operation torque.

Referring now to FIGS. C8 and C9, a ball retaining ring 382 is disposed in a recess 362b for securing the point seal ring unit 371a, retaining ring 382 has a groove 382a with a conical surface 382c defined by an angle for receiving a lock ring 388. The lock ring 388 has a conical surface 388a which is engaged with conical surface 382c, lock ring 388 is constructed as three segments, an angle of the conical surface 388a is substantially same as that of conical surface 382c and equal or less than self-lock angle. The ball 350 is provided with three circumferential thread holes 364 extending to both a groove 366b and cavities 368 on a surface 369c for positioning lock ring 388, each of three screws 390 having a hex shoulder 390a is threaded into thread hole 364 and a nut 391 for moving lock ring 388 in groove 366b. The sizes of cavities 368 should be large enough for operating the screws 390, nuts 391 and small enough for preventing screws 390 and nuts 391 from falling out of the cavities 368. If there is no space for lock ring 388, screw 390 can be provided with a modified conical tip (not shown) engaged with surface 382c. Retaining ring 382 is provided with three access slots 382b for disassembling seal rings unit 371a.

Referring to FIGS. C10, C11, a body retaining ring 380 is disposed in a recess 314 defined by a surface 316b and includes a recess 380m receiving a gasket 394a for sealing between body 302 and retaining ring 380. Retaining ring 380 also has a recess 380n receiving a seat retaining ring 384 and a groove 380a defined by a conical surface 380d with rough surface textures. Seat retaining ring 384 has a bore 384e and a bore 384d defined by a surface 384c, seat retaining ring 384 also includes three circumferential threaded holes 384b extending to a lager groove 384a. A screw 392 is threaded into thread hole 384b and has a larger head 392a engaging with groove 384a with a loose fit, each of three screws 392 is provided with a conical surface 392b urged against conical surface 380d for securing ring 384, an angle of conical surface 392b is substantially the same as that of conical surface 380d.

The body retaining ring 380 also comprises a centric fluid port 380h and an eccentric recess 380k receiving a lock ring 386, lock ring 386 has a conical surface 386b which are engaged with a conical surface 316a defining a groove 310, an angle of the conical surface 386b is substantially same as that of conical surface 316a and less than a self-lock angle. Retaining ring 380 is provided with three circumferential thread holes 380b extending to both three smaller holes 380c and recess 380k. Lock ring 386 is constructed as three segments, each segment of lock ring 386 is inserted into a larger gap between recess 314 and recess 380k, and then moved into a smaller gap position between recess 314 and recess 380k. Three screws 349c are threaded through holes 380b against a bore 386a of lock ring 386 for pressing lock ring 386 against surface 316a and for securing retaining ring 380.

Referring to FIG. C12, seat seal assembly 370a comprises point seal ring unit 371a as a valve member seal assembly and flexible surface seal ring 372a as a body seal assembly. Seal ring 372a is disposed in a taped recess 380s defined by a surface 380g and a recess 380p is secured by retaining ring 384, retaining ring 380 is provided with a groove 380f receiving a gasket 394c for a seal between surface 380g and seal ring 372a, while seal ring unit 371a is disposed in a taped recess 362a defined by a surface 369b and is secured by retaining ring 382, ball 350 is provided with a grove 366a receiving a gasket 394b for a seal between surface 369b and seal ring unit 371a. A peripheral seal surface 373a of flexible seal ring 372a is engaged with a peripheral seal surface 373b of point seal ring unit 371a for forming a point/flexible surface sealing between chamber 318b and 318c, profiles of surfaces of 373a, 373b are substantially the same and can be spherical, conical or other mating shape.

The point seal ring unit 371a comprises two outmost metal holding rings 374a and multiple middle point rings 374b, seal ring unit 371a also comprises two conical back rings 374c, 374d, metal back ring 374d has a little bit larger outside diameter than inside diameter of seal rings unit 371a, so graphite back ring 374c supported by metal back ring 374d generates a compression between a conical surface 376a of seal ring unit 371a and surface 376b of back ring 374c for preventing fluid seeping among rings 374a, 374b, the seal surface 373b of middle point rings 374b is defined by a plurality of rectangle cross section of metal wires. Area of cross sections is between 0.007-0.011 square inch (0.45-7.1 square mm).

The flexible surface seal ring 372a comprises a half-H ring having a seal surface section 378b, a support section 378c and a floating section 378a, the support section 378a is secured by recess 380p defined by a surface 380e and retaining ring 384. A thickness of ring 372a is between 0.01 and 0.18 inch (0.25-4.5 mm), seal ring 372a can be made out of metal or metal with anti-corrosive, abrasive coatings or base metal with a deposit layer with a thickness between 0.005-0.020 inches (0.12-0.5 mm), the depositing process is implemented by a thermal spray process such as High Velocity Oxygen Fuel.

The stem seal assembly 330 also comprises many other shapes of packing rings. Spiral spring ring 332b can be constructed with different shapes of cross section such as rectangle, triangle and cycle. Stem packing 331b can be constructed a metal spring with twisted spiral graphite stripes or PTFE coating or cover, packing 331a can have multiple rings 332a with different shapes of cross sections such as delta, 0, V or other. Stem seal assembly 330 can be used for both reciprocal stem and rotary stem.

Seat seal assemblies 370a, 371b also have a plurality of other seal geometric elements and combination for different applications. Point-line seal ring unit 371b is constructed by sandwiching thin sheet ring 375b between wire rings 375a shown in FIG. C 13, cross section of wire 375a can be also triangle, cycle, square or other shapes, thin sheet ring 375b can be made out of metals, graphite, a thickness of ring 375b is between 0.01-0.18 (0.25-4.5 mm), so total number of basic geometric seal elements is five including (1) the rigid surface seal element defined by a solid part such as or seat as integral part of ball or body like seat section 319a (2) the line seal element defined by the conventional laminated seal ring and an axial laminated seal ring with the coaxial multiple pipes or tubes seal ring like seal unit 171b (3) the flexible surface seal element defined by flexible seal ring 372a (4) the point-line seal element defined by point-line seal ring unit 371b (5) the point seal element defined by point seal ring unit 371a.

Those five geometric seal elements can be constructed either with body 302 or ball 350, seat seal assemblies 370a, 370b can be used as a seal between relative linear or rotary moving parts in a valve such as a butterfly valve, plug valve, gate valve, global valve and check valve. The combinations of the five seal geometric elements provide numerous selections for various applications, for example, total number of combination of the seal elements of seat seal assembly 370a with spherical mating surfaces 373a, 373b in a ball valve is 25 as shown in table 2.

TABLE 2

| Combination | #1 | #2 | #3 | #4 | #5 |
|---|---|---|---|---|---|
| Body | RS | RS | RS | RS | RS |
| Ball | RS | FS | L | P | P/L |
| Combination | #6 | #7 | #8 | #9 | #10 |
| Body | FS | FS | FS | FS | FS |
| Ball | RS | FS | L | P | P/L |
| Combination | #11 | #12 | #13 | #14 | #15 |
| Body | L | L | L | L | L |
| Ball | RS | FS | L | P | P/L |
| Combination | #16 | #17 | #18 | #19 | #20 |
| Body | P | P | P | P | P |
| Ball | RS | FS | L | P | P/L |
| Combination | #21 | #22 | #23 | #24 | #25 |
| Body | P/L | P/L | P/L | P/L | P/L |
| ball | RS | FS | L | P | P/L |

RS = Rigid Surface, FS = Flexible Surface, L = Line, P = Point, P/L = Line/Point

The valve 300 also has a plurality of construction for different applications. Body 302 can be constructed with flange style, or threaded style or spilt bodies, in case of spilt bodies, retaining ring 380 is integral to one of the spilt bodies. Body 302 can be made of various metals, such as stainless steel, alloy steel. Seal ring 372a may be integral to either of body 302 as a solid seat like seat section 319a or ball 350, special hard or anti-corrosive materials should be deposited on seal surface of either seat section 319a or ball 350 or entice wet surface of valve 300. The deposit process should be implemented by thermal spray such High Velocity Oxygen Fuel spraying (HVOF) with a thickness of the deposit material between 0.005-0.020 inch (0.12-0.5 mm).

The valve 300 can be provided with the energy transmission device 190c as shown in FIG. C9, the energy transmission device 190c is disposed in ball 350 for storing and releasing energy when valve 300 is used as a fluid throttling device, the energy transmission device 190c can be disposed in flow fluid passage 304.

Referring to FIG. C14, stem adaptor 327a can be modified as a stem adaptor 327b for connection two stems. Stem adaptor 327b is provided with a bore section 328e which is concentric with section 328a and an eccentric bore section 328d.

The best assembly of valve 300 is accomplished as followings (1) gaskets 394b are inserted in grooves 366a of ball 350, screws 390 are threaded into thread hole 364 and are connected with nuts 391, then seal rings units 371a are disposed in recess 362a, retaining rings 382 are disposed in recess 362b with lock rings 388, screws 390 are tightened up until lock ring 388 fully against surface 382c, then nuts 391 are threaded back fully against wall of cavities 368 (2) gasket 394c is inserted in groove 380f, seal ring 372a is disposed in recesses 380s, 380p, retaining ring 384 with screws 392 is disposed in recess 380n, screws 392 are tightened up (3) assembled ball 350 is inserted passages 304, then thrust bearing 338 with other parts is inserted between ball 350 and boss section 319, pin 342 is moved in groove 358a, finally screw 349b with nut 340 is threaded through threaded hole 338b and hole 312 and against groove 336a (4) assembled retaining ring 380 is inserted in recess 314 with gasket 394a, then each segments of lock ring 386 is inserted into a larger gap between recess 314 and recess 380k and moved to smaller gap between recess 314 and recess 380k, then screws 390 are tightened up (5) assembled gland 334 with stem seal assembly 330 and stem 320 is inserted into body 302, secondary stem seal 344 is inserted into gland 334 screws 349a are threaded through body 302 and urged against surface 334a for securing gland 334 and pressing ring 326.

In best mode of operation, valve 300 are installed in a pipeline system, stem adaptor 327a is coupled with stem 320 for rotating stem 320 between open and closed positions, first, screw 349a should be properly adjusted with no leakage and relatively low operation torques, second, point seal ring units 371a are properly matched with surface seal ring 372a and seat section 319a, if there is an offset, screws 349c should be properly adjusted, otherwise screws 390, nut 391 should be properly readjusted until seals between ball 350 and body 302 reaches.

This invention also provides other novel mechanical joint device almost for all part s in a valve. Most conventional seal ring retaining devices are provided with screws or bolts directly to secure seal rings, such a method not only produces uneven pressing forces on the seal rings with unbalanced forces on the retaining ring, but also has lower reliability with multiple bolting and high a risk of the screws or bolts falling into a pipeline system under vibration or high cycle conditions. With those inclusive retaining rings 380, 382, 384, no screws 349b, 349c, 390, 392 and nuts 391 or lock rings 386, 388 will fall into the pipeline system even under loose condition, with self-lock, conical surface, retaining rings 380, 382, 384, will not loose because of reaction forces, in the contrary, the point forces from screw 349c, 390 and 392 are amplified and evenly distributed to lager surface forces on retaining rings 380, 382, 384, finally eccentric retaining ring 380 provides additional locking mechanism, specially in case of limited space, only one screw 349c is needed to secure one of three segments of lock ring 388 at a larger gap location.

Finally valve 300 is constructed with other novel devices of this invention. The balance dual offsets on ball 350 provide a novel way to reduce rubbing as well as to keep ball 350 in a balanced and stable condition. The offsets can be only on one side for shut-off seal, other side valve without seal ring 371a or 372a can be used for throttling a flow fluid, if there is a limited space, an offset can be used, more importantly with support of stationary gland 344 and stationary thrust stem 336, most of side loading on ball 350 is shifted to gland 344 and lower stem 336, stem 330 mainly supports the operation torque, such an arrangement not only reduces dynamic stem leak and wearing of seat seal assemblies 370a, 370b, but also decreases diameter of stem 330. Unlike conventional ball valves, the upper stem not only supports the operation torque, but also supports side loading from a ball under fluid pressure, that is a main reason for stem and seat leaks.

Although the description above contains many specifications, these should not be construed as limiting the scope of the invention but as merely providing illustration of some of the presently preferred embodiments of this invention.

Thus, the scope of the invention should be determined by the appended claims and their legal equivalents, rather than by the examples given.

I claim:

1. An energy converting device in a fluid system for regulating fluid comprising;
(a) A body with a packing support on top of said body, said body comprises a plurality of configurations including a globe body, threaded body, split-style body, flanged body, lugged body, and a wafer body.
(b) A valve member disposed in said body coupled with a stem for regulating flow fluid;
(c) A joint means between said valve member and said stem;
(d) A seal means comprising;
(1) At least one stem seal assembly for sealing between said stem support and said stem having a bore packing, a stem packing, and a secondary stem seal. When said stem is moving, said stem packing is attached to said stem and said bore packing is attached to said packing support. Said stem packing and said bore packing are closely contacted with each other.
(2) At least one seat seal assembly for sealing between said valve member and said body comprising a body seal assembly and a valve member seal assembly. When said valve member is moving, said body seal assembly is attached to said body, while said valve member seal assembly is attached to said valve member. Said body seal assembly comprises a peripheral seal surface, said valve member seal assembly comprises a peripheral seal surface having a sealing contact with said peripheral seal surface of said body seal assembly, a profile of said peripheral seal surface of said body seal assembly is substantially the same as a profile of said peripheral seal surface of said valve member seal assembly, said profiles are constructed with a plurality of shapes including a conical shape, spherical shape, flat shape, radical and axial mating surface profiles.
(e) At least one mechanical joint means comprising;
(1) An axial assembly having a converting section including at least one engagement surface defined by an angle and a retaining section. Said converting section and said retaining section are respectively constructed with a plurality of combinations including; with said body, said valve member, and said packing support and a retaining ring.
(2) A circumferential device having at least one engagement surface defined by an angle and a plurality of mechanical fastens. Said engagement surface of said axial assembly is engaged with said engagement surface of said circumferential device for converting circumferential movements to axial movements, said angle of said of circumferential device is substantially the same as said angle of said axial assembly. Each of said mechanical fastens disposed in said retaining section for adjusting circumferential movements is constructed with a plurality of forms including thread, offset arrangement between two cylinder axes.
(3) An anti-loose means comprises said engagement surface on said axial assembly and said engagement surface on said circumferential device, said angles are less than a self-lock angle and a lock means.

2. The device of claim 1, wherein said device including;
(a) A control valve, said body is a control valve body including at least one inlet port and at least one outlet port and a recess between said inlet port and said outlet port, said valve member is a plug, said packing support is a bonnet.
(b) A ball valve, said body is a ball valve body having at least one passage, said valve member is a ball, said stem comprises an upper stem and a thrust stem and said packing support is a gland.
(c) A butterfly valve, said body is a butterfly valve body having at least one passage and said valve member is a disc.
(d) A gate valve, said body is a gate valve body having at least one passage and said valve member is a gate.
(e) A plug valve, said body is a plug valve body and said valve member is a plug.
(f) A check valve.
(g) A pressure regulator.
(h) A valve comprises a plurality of internal surfaces having a deposit layer, said deposit layer is bonded by thermal spray process including High Velocity. Oxygen Fuel Spraying (HVOF).

3. The device of claim 1, wherein said device including;
(a) An engine valve for receiving or releasing fluid in and out of an engine comprising said body which is a part of engine block having an integral seat as said body seal assembly; said valve member comprising a first recess and a second recess and a seal-joint means. Said seal-joint means comprising;
(1) Said seat assembly disposed in said body and said valve member comprises said integral seat on said body and said valve member seal assembly disposed in said first recess on said valve member;
(2) Said converting section is constructed with said retaining ring having a groove with said engagement surface, said retaining section is constructed with said valve member having a hole including a plurality of circumferential through thread holes and a groove. Said mechanical fastens comprise a plurality of control screws threaded into said circumferential thread holes, each of said control screws includes one end having said engagement surface which is engaged with said engagement surface of said retaining ring. Said lock means includes a plurality of lock screws urging against said control screws and a snap ring disposed in said groove on said hole of said valve member for preventing said lock screws from falling out.
(b) a smaller control valve comprising said valve member, said valve member including;
(1) A plug having a plurality of axial release holes extending to a plurality of circumferential grooves for fluid communication and a plurality of connecting bores,
(2) A cover having a boss disposed in a bottom bore of said bores on said plug comprises a thread hole and a cap having a thin, flexible wall for absorbing impact of flow fluid. Said cap comprises a plurality of profiles for a plurality of flow characteristics, said flow characteristics include an equal percentage, quick opening and linearity.
(3) A retaining means for securing said cover to said plug comprising a plurality of mechanical fasteners including a screw through said connecting bores into said threaded hole of said cover.
(c) A metering valve for regulating a flow fluid rate in a fluid control system comprises;
(1) Said body is integrated with said body seal assembly. Said body comprises an inlet recess extending to a bottom seat defined by a profile and a plurality of outlet ports on said conical bottom seat of said body, said outlet ports are equally spanned and away from a center of said seat of said body,
(2) Said valve member is integrated with said valve member assembly. Said valve member movably disposed in said recess comprises a predetermined diameter and a tip defined by a profile which is substantially the same as said profile of said bottom seat, said profile comprises a plurality of shapes. Said valve member comprises a plurality of coaxial thin pipes which have a center fluid hole receiving incoming fluid and a plurality of release slots for absorbing fluid impact force and preventing erosion and cavitations, a gap between said valve member and said recess comprises a balanced fluid stream for depressing cavitations and noises.

4. The device of claim 2, said control valve further including;
(a) An energy transmission means disposed in said recess of said valve for releasing, storing fluid energy comprises at least one frame assembly, and at least one wire having a predetermined cross section, which is winded with a plurality of methods on said frame assembly, said methods includes spiral winding with predetermined gaps among a plurality of sections of said wire.
(b) A sleeve disposed between said plug and said energy transmission means includes a plurality of fluid holes equally spanned for fluid communications between a first chamber and a second chamber in said valve, said fluid holes divided into two groups in an opposite direction are located circumferentially away from said outlet port. Said sleeve also comprises a recess defined by a conical surface at a top end and a conical surface at a bottom end.
(c) At least one depressing means for depressing cavitations and noise comprising;
(1) An incoming fluid stream defined by one of said inlet ports
(2) A means for splitting said incoming fluid stream into two fluid streams comprises two passages defined by said two groups of said fluid holes connecting to said recess of said body.
(3) A means for converting said splitting two fluid streams into one outgoing fluid stream comprises a passage defined by one of said outlet ports connected to said recess of said body.
(d) A first seal means for sealing among said bonnet, said body and said sleeve comprises a recess on said bonnet and a bore on said body for receiving a gasket for a seal between said bonnet and said body. Said seal means also comprises a recess defined by said conical surface on said sleeve and a conical surface on said bonnet which is sealing-contact with said conical surface on said sleeve, a profile of said conical surface of said sleeve is substantially the same as said profile of said conical surface of said bonnet;
(e) A second seal means for sealing between said plug and said sleeve comprises a spiral ring and a gasket disposed a groove on said plug, said spiral ring is made out of plurality of materials including metals, said gasket is made out of plurality of materials including a graphite,
(f) A retaining means for securing said body seal ring assembly in said body comprising a lock ring and a groove having a conical surface on said body for receiving said lock ring, said lock ring is constructed as a plurality of segments having a first conical surface and a second conical surface, said first conical surface is urged against said conical surface of said groove, a profile of said first conical surface is substantially the same as a profile of said conical surface of said groove and smaller than a self-lock angle. Said second conical surface is urged against said conical surface at bottom end of said sleeve, a profile of said second conical surface is substantially the same as a profile of said conical surface at bottom end of said sleeve.

5. The device of claim 2, said butterfly valve further including a position means for positioning said stem in said packing support of said butterfly valve. Said position means comprises a position ring disposed in a bore of said packing support and a plurality of keyways on said stem, said position ring includes a hole receiving said stem and a plurality of circumferential keyways receiving a plurality of keys along with said keyways on said stem for preventing a relative movement between said position ring and said stem, said position ring also comprises a moon-shaped groove defined by two surfaces and two control screws threaded through said packing support into said groove by contacting said surfaces for limiting rotation of said stem with predetermined positions and for preventing an axial, outward movement of said stem Said control screws are constructed with a plurality forms including a screw with a limit switch.

6. The device of claim 2, said ball valve further including
(a) An energy transmission means disposed in said ball for releasing, storing, and converting fluid energy comprising one frame assembly, and at least one wire having a predetermined cross section which is winded on said frame assembly with a plurality of methods. said methods includes spiral winding with predetermined gaps among a plurality of sections of said wire;
(b) A ball position means for controlling said ball position including a moon-shape groove having an access slot on a bottom of said ball and a thrust bearing sandwiched between said ball and a boss section on said body having a hole. Said thrust bearing has a hole receiving said thrust stem also includes a boss having a vertical hole receiving a pin with a loose fit and a horizontal threaded hole receiving a control screw. An end of said pin is disposed in said moon-shape groove for limiting rotations of said ball at predetermined positions, said control screw through said threaded hole and said hole is engaged with a groove of said thrust stem for securing said thrust stem and said thrust bearing, a nut is provided to secure said control screw
(c) A stem protection means for securing said upper stem and shifting side loading to said gland comprising a large bore extending to a smaller bore with a predetermined length on a bottom end of said gland and a large section extending to a smaller section with a predetermined length on a bottom end of said upper stem inserting respectively into said large bore and said smaller bore of said gland.

7. The device of claim 2, wherein said ball valve has said body including a through passage and a plurality of coaxial bores on a center line of said passage for receiving said stem including an upper stem and a thrust stem, said valve member includes a symmetric ball having a port lined up with said passage when said ball is on a fully open position, said valve member also comprises two coaxial bores for receiving said upper stem and said thrust stem, said two coaxial bores on said ball are concentric with said coaxial bores of said body, sail ball valve includes at least one of said seat seal assemblies having a spherical profile and a double-offset means for reducing rubbing between said body seal assembly and said valve seal member assembly, said double-offset means comprising;
(a) A first offset on said body seal assembly defined by a first distance between an axis of said coaxial bores on said body and a center of said body seal assembly in a vertical direction, a first offset on said valve member seal assembly on said ball defined by a first distance between an axis of said coaxial bores on said ball and a center of said valve member seal assembly in said vertical direction. Said first distance on said body seal assembly is substantially the same as said first distance on said valve member assembly.
(b) A second offset on said body seal assembly is defined by a second distance between said axis of said coaxial bores on said body and said center of said body seal assembly in a horizontal direction, a second offset on said valve member seal assembly is defined by a second distance between said axis of said coaxial bores on said ball and said center of said valve member seal assembly. Said second distance on said body seal assembly is substantially the same as said second distance said valve member seal assembly.

8. The device of claim 1, wherein said joint means including;
(a) A joint assembly for transmitting axial movements and forces comprising;
(1) Said stem having an O-ring shape groove;
(2) A plurality of lock blocks, each of said block comprises an O-ring shape surface which is engaged with said O-ring shape groove of said stem, a profile of said O-ring shape groove on said stem is substantially the same as a profile of said O-ring shape surface of said lock block, each of said lock block includes a through thread hole and a lock screw having a first end threaded into said threaded hole;
(3) Said valve member having a groove for receiving said lock blocks, each of said lock screws threaded into said threaded hole has a second end urged on said groove for preventing any relative movement between said stem and said valve member in an axial direction, said valve member includes a plurality of axial access bores with predetermined sizes for operating said lock screw and preventing said lock screws from falling out, said valve member also comprises a plurality of access slots for assembling and disassembling said lock blocks into and from said groove.
(b) A joint means for transmitting torques and rotary movements including
(1) Said valve member having two hubs including a through stem hole and at least one integral key holder including a partial keyway located at a middle of said valve member,
(2) Said stem disposed in said stem hole having at least one partial keyway connected with said partial keyway in said key holder as a complete keyway which has a plurality of cross section shape including triangle, rectangle, square, polygons;
(3) At least one key having a predetermined size which is relatively smaller than a clearance between said hub and said key is engaged with said complete keyway between said integral key holder and said stem, profile of said key is substantially same as that of said complete keyways between said stem and said valve member and a plurality of kinds which includes single key, key with set-crew and key with spring, tape key, straight key.

9. The device of claim 1, wherein said bore packing is constructed with a plurality of forms which comprising;
(a) A bore packing disposed in said packing support has a plurality of rings with a predetermined length, each of said rings is made out of a plurality of shapes including a rectangle, delta, cycle, each of said rings is made out of a plurality of materials including a graphite, heat resisted and cryogenic-stable, relatively flexible materials. Said stem packing disposed in a groove of said stem comprises at least one flexible ring having a plurality of shapes including a rectangle, cycle and at least one spiral spring ring having a plurality of shapes including a rectangle, cycle, said spring ring comprises a joint means for preventing relative movement between said stem and said spring ring comprises a plurality of methods including one end of said spring ring inserted into a hole of said stem. Said spring ring is made out of a plurality of materials including a heat resisted and cryogenic-stable, relatively flexible material, spring stainless steel, spring stainless steel with PTFE coating, spring stainless steel with PTFE cover, spring stainless steel with graphite strings and composite materials. Said secondary stem seal comprises a half-S ring disposed in said stem below said bore packing and said stem packing and is urged against a conical bottom of bearing, said secondary stem seal also includes an internal surface for seals between said stem and said bearing, said stem and said bore.
(b) A bore packing has a plurality of packing rings including a lower packing ring, upper packing ring and a pair of upper and lower packing rings, each of said packing rings has a seal section, said packing rings are made out of a plurality of materials including a heat resisted and cryogenic-stable, relatively flexible materials and graphite. Said stem packing comprises a plurality of rings including a down delta ring, upper delta ring and a pair of upper and down delta, each of said delta rings has a cylindrical section and a seal section which is fully engaged with said seal section of said packing rings. A peripheral profile of said seal section of said delta ring is substantially same as a peripheral profile of seal section of said packing ring, said peripheral profile comprises a plurality of configurations including a conical profile and spherical profile. Said delta rings are made out of a plurality of materials including a heat resisted and cryogenic-stable, relatively flexible materials, spring stainless steel, metal with anti-friction coatings and composite materials, said cylindrical section of said delta ring is inserted by said stem with an interference fit through a plurality of methods including a thermal process method including heat enlarging and cool shrinking. Said secondary stem seal disposed between said stem and a stem bore comprises a metal half-S ring and at least one graphite delta ring for an axial constrain and seal, said metal half-S ring has an inner surface with a transition fit with said stem and an outer surface with a transition fit with said stem bore.
(c) A bore packing disposed in a groove of said packing support comprises at least one packing ring, said packing ring is made out of plurality of materials including a heat resisted and cryogenic-stable, relatively flexible material and graphite, reinforced PTFE and a soft metal. Said stem packing disposed in a groove of said packing support has a pair of rings and at least one spiral spring ring between said pair of rings, said pair of rings is made out of a plurality of materials including a heat resisted and cryogenic-stable, relatively flexible materials, graphite, reinforced PTFE, said spring ring comprises a joint means for preventing relative movement between said stem and said spring ring comprises a plurality of methods including one end of said spring ring inserted into a hole of said stem, said spring ring is made out of a plurality of material including a heat resisted, cryogenic-stable, relatively flexible material, spring stainless steel, spring stainless steel with PTEF coating, and spring stainless steel with PTEF cover, spring stainless steel with graphite string and composite materials. Said secondary seal disposed in a recess of said packing support with a transition fit comprises a plurality of coaxial delta rings, each of said delta rings has an upper surface engaged with said packing support and a lower surface engaged with a surface of said valve member for seal between said valve member and said stem. Said secondary seal is made out of a plurality of material including a heat resisted, cryogenic-stable, relatively flexible material.

10. The device of claim 1, wherein said seat seal assembly including a plurality of geometric seal elements and a plurality of combinations of said geometric seal elements, said geometric seal elements comprising;
(a) A point-line seal element defined by two outmost metal holding rings and multiple line seal rings sandwiching a plurality of point seal rings, and a graphite conical back ring and a conical metal back ring having a larger outside diameter, so said graphite back ring supported by said metal back ring generates a compression for preventing fluid seeping. Said seal surface of middle point rings is defined by a plurality of cross sections of wires, said wires comprise a plurality of shapes including a rectangle, triangle and cycle with a predetermined area. Each of said line seal rings is defined by an annular, thin ring with a predetermined thickness. Said wires and said thin rings are made out of a plurality of materials including a heat resisted and cryogenic-stable, relatively flexible materials, spring stainless steel, stainless steel with graphite cover and graphite.
(b) A rigid surface seal element defined by an integral part of said valve member, an integral part of said body and a solid part;
(c) A line seal element defined by a radical laminated seal ring and an axial, annular, laminated seal ring having a plurality of coaxial pipes with a flexible ring for preventing fluid seeping;
(d) A flexible surface seal element defined by a half-H seal ring having a seal surface section for sealing, a support section to be secured and a floating section to be floated, said seal ring is made out of metal and metal with anti-corrosive abrasive coatings.
(e) A point seal element defined by two outmost metal holding rings and multiple middle point rings and a conical graphite back ring and a conical metal back rings, said metal back ring has a larger outside diameter than an inside diameter of said point seal element, said graphite back ring supported by said metal back ring generates a compression for preventing fluid seeping, said seal surface of middle point rings is defined by a plurality of cross sections of wires, said wires comprises a plurality of shapes including rectangle, triangle and cycle with a predetermined area. Said wires are made out of a plurality materials including metal, graphite, PTFE and composite materials.

11. The device of claim 1, wherein said converting section is constructed with a plurality of forms which including;
(a) A converting section is constructed with an annular ring having a first surface against a top surface of said bore packing and said engagement surface, said retaining section is constructed with said packing support having a plurality of circumferential thread holes. Said mechanical fastens comprise a plurality of control screws, each of said screws threaded in said thread holes has said engagement surface engaged with said engagement surface on said ring. Said lock means comprises a friction induction texture on said engagement surface of said gland and a plurality of nuts for securing said screws and said gland.
(b) A converting section is constructed with a plate having said engagement surfaces, said plate is disposed at a bottom of said stem, and said retaining section is constructed with said body having a bottom bore receiving said plate and said stem and having at least one circumferential thread hole. Said mechanical fastens comprise a block having at least one T-slot and said engagement surface engaged with said engagement surface on said plate and one control screw, said controls crew has a first end threaded into said circumferential threaded hole and a second end with large head disposed in said T-slot of said block. Said lock means comprises a lock screw threaded in said circumferential threaded hole and urged against said first end of said control screw.
(c) A converting section is constructed with said valve member including a recess having a groove with said engagement surface, said retaining section is constructed with said retaining ring having a surface to secure said valve member seal assembly and a plurality of circumferential thread holes, each of said circumferential thread holes is extending to an operating hole. Said mechanical fastens comprise a plurality of control screw threaded in said thread holes, each of said control screws has said engagement surface engaged with said surface on said retaining ring. Said lock means comprises said operating holes with predetermined sizes for preventing said control screws from failing out of said member and a friction induction texture on said surface of said valve member.
(d) A converting section is constructed with said retaining ring having said engagement surface for jointing said valve member and said member seal assembly, said retaining section is constructed with said valve member receiving said retaining ring including a hole having a plurality of circumferential thread holes. Said mechanical fastens comprise a plurality of control screws threaded in said circumferential thread holes, each of said screws has said engagement surface engaged with said engagement surface on said retaining ring. Said lock means comprises a plurality of lock screw threaded into each of said thread holes against each of said control screw and a friction induction texture on said engagement surface of said retaining ring.
(e) A converting section is constructed with said retaining ring including a recess having a groove with said engagement surface for jointing said valve member seal assembly and said valve member seal assembly, said retaining section is constructed with said valve member receiving said retaining ring including a hole having a plurality of circumferential thread holes and a groove. Said mechanical fastens comprise a plurality of control screws threaded in said circumferential thread holes, each of said control screws has said engagement surface engaged with said engagement surface of said retaining ring. Said lock means comprises a plurality of lock screws threaded into each of said thread holes against each of said control screws and a friction induction texture on said engagement surface of said retaining ring and a snap ring disposed in said groove in said hole of said valve member.
(f) A converting section is constructed with said retaining ring having a recess including a groove with said engagement surface for jointing said valve member seal assembly and said valve member, said retaining section is constructed with said valve member having a recess including a plurality of circumferential thread holes extending through a plurality of cavities. Said retaining ring disposed in said recess on said valve member comprises a groove receiving a gasket for sealing between said valve member seal assembly and said retaining ring, said retaining ring includes a plurality of access slots for disassembling said valve member seal assembly. Said mechanical fastens comprises a lock ring having a plurality of segments and a plurality of control screws, said lock ring has said engagement surface engaged with said engagement surface on said member retaining ring, each of said control screws has a first end threaded through said circumferential thread hole and urged against said lock. Said lock means comprises a plurality of lock screws and said cavities, each of said lock screws has a first end to urged against said control screw and a second end threaded in said thread hole in said cavities, each of said cavities has a predetermined size for operating said screw and said lock screw and for preventing said screw and lock screw from falling out.
(g) A converting section is constructed with said body including a recess having a groove with said engagement surface, said retaining section is constructed with said retaining ring disposed in said recess for jointing said body seal assembly and said body. Said retaining ring comprises a first groove receiving a gasket for sealing between said retaining ring and said body seal assembly and a second groove having a plurality of circumferential thread holes. Said mechanical fastens comprise a lock ring having a plurality of segments and a plurality of screws, said lock ring movably disposed between said groove on said retaining ring and said groove on said recess of said body has said engagement surface engaged with said engagement surface on said body, each of said segments of said lock ring has a T-slot, each of said screws has a first end threaded in said thread hole and a second end with a larger-head disposed in said T-slot of said lock ring for operating said lock ring. Said lock means comprises said T-slots for preventing said screws from falling out.
(h) A converting section is constructed with said retaining ring having a recess including a groove with said engagement surface for jointing said valve member seal assembly and said valve member, said retaining section is constructed with said valve member having a recess with a groove having a plurality of circumferential thread holes extending to a plurality of cavities. Said retaining ring includes a plurality of access slots for disassembling said valve member seal assembly. Said mechanical fastens comprise a lock ring having a plurality of segments and a plurality of control screws threaded in said circumferential thread holes, said lock ring has said engagement surface engaged with said engagement surface on said retaining ring, said lock ring is movably disposed between said groove on said valve member and said groove on said retaining ring, each of said control screws has a first end and a second end urged against said lock. Said lock means comprises a plurality of lock nuts and said cavities, each of said lock nut has a first end including a threaded hole receiving said first end of said control screw and a second end urged against said cavity, each of said cavities has a predetermined size for operating said control screws and said lock nuts and for preventing said control screws and said lock nuts from falling out.
(i) A converting section is constructed with said valve member having a recess including a groove with said engagement surface, said retaining section is constructed with said retaining ring disposed in said recess on said valve member for jointing said member seal assembly and said member. Said retaining ring comprises a surface to secure said valve member seal assembly and a groove having a plurality of circumferential thread holes. Said mechanical fastens comprise a plurality of control screws, each of said control screws includes a first end having said engagement surface engaged with said engagement surface on said member and a second end threaded in said thread holes with a large head. Said lock means comprises a friction induction texture on said engagement surface on said valve member and said large head with a predetermined size.
(j) A converting section is constructed with said body having a centric recess including a groove with said engagement surface, said retaining section is constructed with said retaining ring disposed in said recess on said body. Said retaining ring comprises a centric port and a first recess receiving a gasket with said recess on said body for sealing between said body and said retaining ring, said retaining ring comprises a second eccentric recess having a plurality of circumferential thread holes extending to a plurality of holes on said port. Said mechanical fastens comprise a lock ring having a plurality of segments and a plurality of control screws, said lock ring has said engagement surface engaged with said engagement surface on said body, each of said control screw has a first end urged against said lock ring and a second end threaded in said thread hole. Said lock structures comprises a gap between said second eccentric recess and said centric recess on said body for preventing said segments of said lock ring from falling out and said circumferential threaded holes with predetermined sizes for preventing said screws from falling out.

12. A seat seal-joint means in a fluid system for sealing and jointing having a plurality of components including bodies, members and retaining rings comprising;
(a) At least one seal assembly comprising;
(1) A body seal assembly attached to said body of said system having a peripheral seal surface;
(2) A member seal assembly attached to said member of said system having a peripheral seal surface which is sealing-contact with said peripheral seal surface of said body seal assembly, a profile of said peripheral seal surface of said member seal assembly is substantially the same as a profile of said peripheral seal surface of said body seal assembly;
(b) At least one mechanical joint means comprises a plurality of joints including a joint between said body and said body seal assembly, a joint between said member seal assembly and said member, a joint between said two said bodies, and a joint between split two sections of said body.

13. The seat seal-joint means of claim 12, wherein said seat seal assembly has a plurality of said profiles including a conical shape, spherical shape, flat shape, radical and axial mating surface profiles, a plurality of geometric seal elements and a plurality of combinations of said geometric seal elements. Said seat seal assembly is made out of a plurality of materials including metals, plastics, rubbers and graphite, composite materials and metals with a plurality of coating materials with a predetermined thickness, said coating materials are implemented by thermal spray process such as High Velocity Oxygen Fuel, said geometric seal elements comprising;
(a) A point-line seal element is defined by two outmost holding rings, multiple line rings sandwiching a plurality of point rings, and a conical, flexible back ring and a conical, rigid back ring having a larger outside diameter, said flexible back ring supported by said rigid back ring generates a compression for preventing fluid seeping, said seal surface of said point rings is defined by a plurality of cross sections of wires including a plurality of shapes including a rectangle, triangle and cycle with a predetermined area, each of said line rings is defined by an annular thin ring having a predetermined thickness;
(b) A rigid surface seal element is defined by an integral part of any of said components including said member, said body, and a solid part in said system;
(c) A line seal element is defined by a radical laminated seal ring and an axial laminated seal ring having a plurality of pipes in coaxial manner with a flexible ring for preventing seeping in said axial laminated seal ring, each of said pipes has a predetermined thickness and a fit;
(d) A flexible surface seal element is defined by a half-H ring having a seal surface section for sealing, a support section to be secured and a floating section to be floated, said ring has a predetermined thickness;
(e) A point seal element is defined by two outmost holding rings and multiple middle point rings, a conical flexible back ring, and a conical rigid back ring, said rigid back ring has a larger outside diameter than an inside diameter of said point rings and said holding rings, said flexible back ring supported by said rigid back ring generates a compression for preventing fluid seeping. Said seal surface of middle point rings is defined by a plurality of cross sections of wires, each of said cross sections of said wires having a predetermined area comprises a plurality of shapes including a rectangle, triangle and cycle.

14. The seat seal-joint means of claim 12, wherein said mechanical joint means comprising;
(a) An axial assembly having a converting section including at least one engagement surface defined by an angle and a retaining section. Said converting section and said retaining section are constructed with a plurality of combinations.
(b) A circumferential device comprises at least one engagement surface defined by an angle and a plurality of mechanical fastens. Said surface of said circumferential device is engaged with said surface of said axial assembly for converting circumferential movements to axial movements, said angle of said circumferential device is substantially the same as said angle of said axial assembly. Each of said mechanical fastens disposed in said retaining section for adjusting circumferential movements is constructed with a plurality of forms including thread, offset arrangement between two cylindrical surfaces.
(c) An anti-loose means comprises a plurality of kinds including said engagement surface on said circumferential device and said engagement surface on said axial assembly, said angles are less than a self-lock angle for preventing an disengagement between said axial assembly and said circumferential device and a lock means for preventing said fastens from falling out,

15. The seat seal-joint means of claim 12, wherein said converting section is constructed with a plurality of forms which comprising;
(a) A converting section is constructed with said member including a recess having a groove with said engagement surface, said retaining section is constructed with said retaining ring having a surface to secure said member seal assembly and a plurality of circumferential thread holes, each of said circumferential thread holes is extending to an operating hole for operating said mechanical fastens, said mechanical fastens comprise a plurality of control screws threaded in said thread holes, each of said control screws has said engagement surface engaged with said engagement surface on said retaining ring. Said lock means comprises each of said operating holes with a predetermined size for preventing said screw from failing out and a friction induction texture on said surface of said member.
(b) A converting section is constructed with said retaining ring having said engagement surface for jointing said member and said member seal assembly, said retaining section is constructed with said member receiving said retaining ring including a hole having a plurality of circumferential thread holes. Said mechanical fastens comprise a plurality of control screws threaded in said circumferential thread holes, each of said control screws has said engagement surface engaged with said engagement surface on said retaining ring. Said lock means comprises a plurality of lock screws threaded into each of said thread holes against each of said control screws and a friction induction texture on said engagement surface of said retaining ring.
(c) A converting section is constructed with said retaining ring including a recess having a groove with said engagement surface for jointing said member and said member seal assembly, said retaining section is constructed with said member receiving said retaining ring including a hole having a plurality of circumferential thread holes and a groove. Said mechanical fastens comprise a plurality of control screws threaded in said circumferential thread holes, each of said control screws has said engagement surface engaged with said engagement surface of said retaining ring. Said lock means comprises a plurality of lock screws threaded into each of said thread holes against each of said control screws and a friction induction texture on said engagement surface of said retaining ring and a snap ring disposed in said groove in said hole of said member.
(d) A converting section is constructed with said retaining ring having a recess including a groove with said engagement surface for jointing said member seal assembly and said member, said retaining section is constructed with said member having a recess including a groove with a plurality of circumferential thread holes extending through a plurality of cavities. Said retaining ring disposed in said recess on said member comprises a groove receiving a gasket for sealing between said member seal assembly and said retaining ring, said retaining ring includes a plurality of access slots for disassembling said seat seal assembly. Said mechanical fastens comprise a lock ring having a plurality of segments and a plurality of control screws, said lock ring has said engagement surface engaged with said engagement surface on said retaining ring, said lock ring is movably disposed between said groove on said member and said groove on said retaining ring, each of said control screws has a first end threaded through said circumferential thread hole and urged against said lock ring. Said lock means comprises a plurality of lock screws and said cavities, each of said lock screws has a first end to urged against said control screw and a second end threaded in said thread hole on said cavity, each of said cavities has a predetermined size for operating said control screw and said lock screw and for preventing said control screw and said lock screw from falling out.
(e) A converting section is constructed with said body including a recess having a groove with said engagement surface, said retaining section is constructed with said retaining ring disposed in said recess for jointing said body seal assembly and said body. Said retaining ring comprises a first groove receiving a gasket for sealing between said retaining ring and said body seal assembly and a second groove having a plurality of circumferential thread holes. Said mechanical fastens comprise a lock ring having a plurality of segments and a plurality of screws, said lock ring movably disposed between said groove on said retaining ring and said groove on said recess has said engagement surface engaged with said engagement surface on said body, said each of said segments of said lock ring has a T-slot, each of said screws has a first end threaded in said thread hole and a second end with a larger-head disposed in said T-slot of said lock ring for operating said lock ring. Said lock means comprises said T-slots for preventing said screws from falling out.
(f) A converting section is constructed with said retaining ring having a recess including a groove with said engagement surface for jointing said member seal assembly and said member, said retaining section is constructed with said member having a recess with a groove having a plurality of circumferential thread holes extending to a plurality of cavities. Said retaining ring includes a plurality of access slots for disassembling said member seal assembly. Said mechanical fastens comprise a lock ring having a plurality of segments and a plurality of control screws threaded in said circumferential thread holes, said lock ring has said engagement surface engaged with said engagement surface on said retaining ring, said lock ring is movably disposed between said groove on said member and said groove on said retaining ring, each of said control screws has a first end and a second end urged against said lock ring. Said lock means comprises a plurality of lock nuts and said cavities, each of said lock nut has a first end including a threaded hole receiving said first end of said screw and a second end urged against said cavities, each of said cavities has a predetermined size for operating said control screws and said lock nut and for preventing said control screw and said lock nuts from falling out.
(g) A converting section is constructed with said member having a recess including a groove with said engagement surface, said retaining section is constructed with said retaining ring disposed in said recess on said member for jointing said member seal assembly and said member. Said retaining ring comprises a surface to secure said member seal assembly and a groove having a plurality of circumferential threaded holes. Said mechanical fastens comprise a plurality of control screws, each of said screws includes a first large-head end having said engagement surface engaged with said engagement surface on said member and a second end threaded in said threaded hole. Said lock means comprises a friction induction texture on said engagement surface on said member and said large-heads having predetermined sizes.
(h) A converting section is constructed with said body having a centric recess including a groove with said engagement surface, said retaining section is constructed with said retaining ring disposed in said recess on said body. Said retaining ring comprises a centric port and a first recess receiving a gasket with said recess on said body for sealing between said body and said retaining ring, said retaining ring comprises a second eccentric recess having a plurality of circumferential thread holes extending to a plurality of holes on said port. Said mechanical fastens comprise a lock ring having a plurality of segments and a plurality of control screws, said lock ring has said engagement surface engaged with said engagement surface on said body, each of said control screw has a first end urged against said lock ring and a second end threaded in said thread hole. Said lock means comprises a gap between said second eccentric recess on said retaining ring and said centric recess on said body for preventing said segments of said lock ring from falling out and said circumferential threaded holes having predetermined sizes for preventing said control screws from falling out.

16. An energy transmission means in a fluid system for transmitting energy comprising;
(a) At least one frame assembly, a plurality of said frame assemblies and said frame assembly with a stacked manner have a plurality of installation methods including a coaxial manner with a plurality of mechanical fasteners, a coaxial manner with point-welding and a coaxial manner with said mechanical fasteners and said point-welding;
(b) At least one wire having a predetermined area of cross section, said wire is attached to said frame assembly with a plurality of assembly methods including a winding and a winding with point-welding;

17. The energy transmission means of claim 16, wherein said energy transmission means is made out of a plurality of materials including metals, plastics, rubbers, piezoelectric materials, cements, and composite materials comprising;
(a) An annular, rigid frame assembly having at least two cylindrical ring sections and at least two rib sections connected to said two ring sections. Said wire on said frame has a flexible, spiral winding with predetermined gaps among a plurality of sections of said wire.
(b) A stacked rigid frame assembly having a plurality of rigid rings which are stacked with said installation method, a plurality of said wires on said rigid rings has a tightly, spiral winding with point-welding and predetermined gaps among a plurality of sections of said wires.
(c) A rigid frame assembly having at least two ring sections and at least two rib sections connected to said two ring sections, a first of said ring sections is larger than a second of said ring sections. Said wire on said frame has a flexible, spiral winding with predetermined gaps among a plurality of sections of said wire.
(d) A stacked rigid frame assembly including a plurality of separating plates, a plurality of rigid rings which is larger than said plates in terms of diameter, said rings and said plates are stacked with said installation method, a plurality of said wires are winded on said rings with predetermined gaps among a plurality of sections of said wires, said separating plates are sandwiched between said rings for prolonging flow fluid paths. Said stacked frame assembly is constructed with said installation methods.
